(19) United States
(12) Patent Application Publication
(10) Pub. No.: US 2014/0174277 A1
(43) Pub. Date: Jun. 26, 2014

(54) MUSICAL WATER INSTRUMENT OR WATER FILLED INSTRUMENT HAVING RIGID PIPES CONNECTED TO ELASTIC OR RIGID MEDIA

(71) Applicant: Steve William Stephen George Mann, Toronto (CA)

(72) Inventor: Steve William Stephen George Mann, Toronto (CA)

(21) Appl. No.: 13/355,338

(22) Filed: Jan. 20, 2012

(51) Int. Cl. G10B 1/06

(52) U.S. Cl. CPC G10B 1/06
USPC 84/331

(57) ABSTRACT

A musical instrument or multimedia input device is disclosed. User input is by hitting or striking water in order to produce an at least partially transient acoustic disturbance, vibrations, or change in the water. In one embodiment rigid pipes of various lengths or diameters emit fluid for being struck by a user at an open end of each pipe. The other end of each pipe is connected to an elastic tubing or other elastic medium, such as a diaphragm or bulb, resulting in a hydraulic resonator. In another embodiment the resonators are formed from variously sized bottles or flasks encased in cement, except for the mouths of the bottles. Each hydraulic resonator may be fitted with a sensor that senses the vibrations in the water and amplifies the vibrations into a sound reproduction system, such as an entirely acoustic impedance matcher or an electrical amplification system.

### FIELD OF THE INVENTION

The present invention pertains generally to a new kind of hydraulic instrument, hydraulic user-interface, or input/output device that may be used to control another multimedia system or events.

### BACKGROUND OF THE INVENTION

Existing musical instruments are divided into three categories: strings, percussion, and wind. Strings are essentially one dimensional solids (i.e. they are long and thin, having a relatively small cross section). Percussion is typically a two-dimensional (i.e. flat and relatively thin) or three-dimensional (bulk) solid. Wind instruments run on matter in its gaseous state. Thus the three categories are:

1. one-dimensional solids;

2. multi-dimensional solids;

3. gas (wind, i.e. aelophonic or aerophonic).

More generally, various researchers have categorized all known musical instruments into five catogories: idiophones, membranophones, chordophones, aerophones, and electrophones. This categorization scheme was devised to categorize all possible musical instruments either known or to be made in the future See Margaret Kartomi, On Concepts and Classifications of Musical Instruments, University of Chicago Press Books, 1990, 349 pp.

This system originated thousands of years ago, was adopted by Victor-Charles Mahillon, and then further refined by Hornbostel and Sachs, and is often referred to as the Hornbostel Sachs Musical Instrument Classification Scheme.

The first three categories refer to solid matter, in three, two, and one dimension, i.e. idiophones make sound from bulk (3d) solid matter. Membranophones make sound from membranes (flat thin, essentially 2 dimensional solid matter). Chordophones make sound from stings which are essentially one dimensional solid matter.

In summary, this musical instrument classification scheme is as follows:

1. idiophones=3-D solids;

2. membranophones=2-D solids;

3. chordophones=1-D solids;

4. aerophones=gases;

5. electrophones.

These categories describe how the sound is produced, initially. For example, an electric guitar is still a chordophone because the sound comes from a vibrating chord (string), regardless of the fact that it may be further processed downstream (e.g. by effects pedals and the like, once the sound is already made by the vibrating string).

Another state-of-matter, namely liquid, has found relevance in musical instruments. For example, the ancient Greeks and Romans used water as a supply of power, in order to blow air into organ pipes. These ancient instruments, known as the “water organ” or “hydraulis”, used water as a power source, or as a means to store energy, which was then used to push wind through organ pipes. Thus the water organ and the hydraulis were aerophones.

In a similar way, modern church organs are examples of water organs because they use hydro-electricity (electricity that is generated by a waterfall) as a source of power to run the electric motor that powers the blower, which blows the wind (air) into the pipes to make the sound.

Sounds can also be produced underwater. For example, municipal swimming baths, various public and private pools, and the like, often have underwater loudspeakers so that music can be played for people to hear underwater. This also facilitates safety, so that announcements over the Public Address (PA) system can be heard underwater.

Some animals such as dolphins and porpoises can make sounds underwater. They do this by having air pockets in which they make sound in air, which then is audible underwater.

Previously I invented a musical instrument that I call a hydraulophone in which sound is produced and/or controlled by vibrations in liquid matter. Typically the hydraulic fluid is water, and the instrument typically comprises 12 finger holes along the length of a pipe that resembles a giant Irish tin-whistle or recorder-flute. Water emerges from the 12 finger holes, and the instrument is played by inserting one or more fingers into or onto one or more of the finger holes to stop or partially stop water from emerging. Blocking the water produces a gentle soothing organ-like sound or a flute-like sound. Each finger hole corresponds to a note on a natural musical scale, and chords may be played by blocking the water from coming out of more than one hole simultaneously. See, for example, http://FUNtain.ca

See also my U.S. Pat. No. 7,551,161, and associated priority documents, such as, for example, Canadian Patent 2499784, Dec. 30, 2004.

Due to its gentle soothing sound and experientiality, the hydraulophone has found many uses in wellness centres, water therapy, rehabilitation, and the like, and its spirtually uplifting quality has been realized in its use as the organ for church services, concerts, playing hymns, and the like.

Its ability to smoothly vary a sound sculpture makes it useful for motion picture sound tracks, and as a replacement for, or use with strings ensembles and other fluidly flowing sound textures.

It has also been used in live theatrical productions to provide the accompanying music or sound track.

The hydraulophone is also being widely used in waterparks and children's play areas, where its slow and gently varying sound remains pleasantly soothing, even when children play notes at random, or play random chords and clusters.

More recently it is being adopted by rock and roll, and jazz musicians. A common sentiment among jazz piano players is that it would be nice if the hydraulophone responded more quickly, so that it could be used for jazz funk, reggae, and the like. It has been said that it would be nice if the family of hydraulophonic instruments offered “quick attack” capability of behaving like a guitar or piano, in addition to offering the ability to sustain notes like an organ or violin.

### SUMMARY OF THE INVENTION

The following briefly describes my new invention. The invention typically comprises a plurality of rigid pipes, each terminated in a bulbous or elastic medium, or a medium that is both bulbous and elastic. The pipes are referred to as “necks” and embodiments of the bulbous medium are referred to as “bulbs”.

I say that the necks are rigid, in the sense that they do not need to flex. Thus the necks need not be perfectly rigid, and in fact may be made of simple plastic material like a plastic drink bottle, in which the neck and bulb portion are of the same material. Generally the whole bottle can be somewhat rigid, or, alternatively the bulb can be more elastic than the neck, though not to limit the scope of the invention, as the entire bottle (neck and bulb) can also be made of identically rigid or less rigid material.

Roughly speaking, my invention is a musical instrument made from a plurality of bottles, played in a totally new way.

Bottles are commonly used to make music in one of two ways:
idiophonically: bottles are struck like the bars of a xylophone, and the bottles can be partially filled with liquid such as beer or water. The liquid changes the tuning, i.e. as more liquid is poured in, the pitch generally decreases. Sound comes from vibrations in solid matter from which the bottles are made (e.g. glass), and the liquid's role is merely for tuning;
aerophonically (aelophonically): sound is made by blowing across the open mouths of the bottles. The bottles function much like a pan flute. The instrument can be tuned by having varying amounts of liquid in the bottles. Sound comes from vibrations in the air in the bottles, and if liquid is present, it raises the pitch by occupying space in the bottle.
   In neither case does the sound come from vibrations in the liquid in the bottles.

My invention uses a plurality of pipes connected to bulbous or elastic media. Some embodiments can be constructed from a plurality of bottles, each forming a resonator, in which the initial sound production is due, at least in part, to vibrations in liquid matter. Thus the liquid's role goes beyond merely tuning of the instrument, to being essential to the sound production.

In some embodiments the invention includes a fipple or edge or other form of steady-state whistle or the like, associated with each pipe, that allows the invention to be used to make steady tones like an organ or violin. Examples of this embodiment include an underwater pipe organ or organ in which the pipes are water-filled.

But many embodiments the new invention also offer a very fast-responding percussion-oriented hydraulophone or hydraulophone-like instrument. Informally and metaphorically speaking, these embodiments of the invention are to a guitar or piano, as other embodiments of the hydraulophone invention are to a pipe organ or flute.

Now that I have said how the new invention compares to earlier hydraulophones, let me also say how it relates to even older instruments, such as traditional instruments previously known throughout human history. Whereas previous musical instruments use solid or gas or informatics (e.g. electrophones) as the sound source, and user interface, the new invention makes possible new forms of sound production and/or user-interface possibilities using liquids, and in particular, played by striking liquids, or by striking elastic media in communication with liquids, directly (e.g. hitting spherical bulbs with mallets or the hands) or indirectly (e.g. it is possible to have a keyboard-operated hydraulophone).

One drawback of the earlier hydraulophones is that the ruggedized versions installed in children's playgrounds and waterparks tended to respond more slowly, owing to the need to mitigate the destructive effects of water hammer.

Some embodiments of the new invention exploit the effects of water hammer in order to create a dramatic and forceful transient response based on the immediate and powerful forces that liquids can create.

For example, one aspect of the invention allows an aquatic play device, fountain, pipe, hot tub, or the like to be equipped with a row of finger or hand holes from which water emerges to form a row of water openings that can be struck or slapped by a user.

Inside the device, there is, in some embodiments, the capacity to hold water in a rigid-walled straight tube connected to each hole, and then connected to each of those water-holding capacities, there is an elastic tubing.

In one embodiment I used 12 rigid plastic toilet/faucet tubes, cut to various lengths to form a natural scale from a 220 CPS (Cycles Per Second) “A” up to a 660 CPS high “E”. Each rigid toilet tube was connected to an elastic hose of equal length. The hoses were connected to a manifold to supply water to all of them.

In one prototype embodiment, which I built into a Jacuzzi-style bath tub in my bathroom, I used Schedule 160 stainless steel pipes, of various lengths, to create a natural hydraulophone scale (110 CPS “A” through 330 CPS “E”). The lengths of the pipes ranged from approximately 12 inches (approx. 305 cm) for the low A down to approximately 4 inches (approx. 102 cm) for the high “E”. The very rigid Schedule 160 pipes were supplied by elastic hoses.

In some embodiments, a one or more hydrophones (or underwater microphones) listens to the sound made by the vibrating water. The outputs of the hydrophones are electrically amplified, and sometimes various auditory effects processors are used, or other processors are used to generate other multimedia effects, not necessarily limited to auditory effects.

In another embodiment of the invention, a user-interface comprises a dozen or so 3 inch pipes (approx. 76 cm in nominal diameter), of various lengths, each connected to an identical rubber elastic medium, each of which has a filling nipple. The pipes are supplied by a gentle stream of water that maintains a meniscus that is concave downwards. The instrument is played by slapping the meniscus with the palm of the hand. The resulting shockwaves, water-hammer, or the like, sets a column of water into transient disturbance such that it settles into an oscillatory motion that decays exponentially, like that of a struck string on a piano. Oscillations occur due to the interaction between the capacity to hold a mass of water in the pipe, and the elasticity of the end cap on the bottom of each pipe.

I made another prototype from flushometer diaphragms that oscillate at a specific frequency with a specific amount of water column above each one, played, again, by slapping the water directly on its end point. It is possible with the instrument to cup the hands in various ways to bend the pitch up or down a little bit, as well as to attain a wide variety of different sounds from each finger or hand hole.

In another aspect of the invention a separate hydrophone is used to pick up the sound made by each sound-producing element. This allows, for example, separate signal processing for each note, or separate amplification for each note so that the sounds can be distributed throughout a waterpark or public art installation.

In another embodiment of the invention, the entire instrument is cast from one piece of concrete, and the elastic mechanisms consist of water reservoirs, of cross-section that is significantly larger than the pipes leading from the finger or hand holes. In this way, the elasticity is due to the small but nonzero compressibility of the liquid.

In another embodiment of the invention, the elastic element consists of a similar large bulbous reservoir housed in an elastic material, such that a portion of the elasticity is due to the small but nonzero compressibility of the liquid, and a portion of the elasticity is due to the material housing the liquid. I made some prototypes, for example, from recycled plastic or glass drink bottles. Other embodiments of the invention are made from one large piece of material, such as a TIG (Tungsten Intert Gas) welded frame, from which surplus fire extinguishers are suspended, the fire extinguishers being cut shorter or longer and TIG welded back together, in various sizes, and suspended from their hydraulic-Fidiophonic nodal points. Alternatively, the entire instrument may be molded from or made of a single piece of plastic. This facilitates low-cost mass production.

In another aspect of the invention, notes are changed by changing the length of the pipes, their diameter (both of which affect the capacity) and the spring or elastic mechanism or the like.

In another aspect of the invention, each finger hole of the instrument leads directly to a column of fluid, such that pressing the finger deeper into the finger hole shortens the column and increases the resonant frequency of each note, thus allowing greater musical expressivity.

Some embodiments of the invention are entirely acoustic. Other embodiments are merely user-interface devices. Many preferred embodiments use acoustically-generated sounds as input to effects such as computerized processor or the like, in such a way that the overall instrument is not an electronic instrument but is more akin to an electric guitar or other acoustically-originated but electrically amplified instrument.

On professional hydraulophones for concert performance, the water jets are often arranged like the keys on a piano, and the instrument is played by pressing down on one or more of the water jets, one for each tone of a diatonic or chromatic scale. In some embodiments there is one acoustic sounding mechanism inside the instrument for each finger or hand hole or other user-interface port. Whenever a finger taps on the water bubbling out of the UI (user interface) port, sound is generated.

A preferred embodiment of the hydraulophone consists of a housing that has at least one hole in it, through which water emerges, trickles, or sits. The hole and the water in it comprise a user interface, and by tapping one's fingers or palm on or near the hole, one can intricately create sound, and expressively vary the dynamics, timbre, and pitch of each note.

Besides the normal way of playing music on such a water-hammer piano, the instrument's water jets can be used simply as a user-interface and controller for other multimedia devices or other devices. We refer to such a controller as a “watertouch controller” or “water controller” or “splash controller”, or “splash surface”, or, if in the form of a projection surface as well, as a “splash page” (See “flUId streams: Fountains that are keyboards with nozzle spray as keys that give rich tactile feedback and are more expressive and more fun than plastic keys”, in Proceedings of the 13th annual Association of Computing Machinery (ACM), international conference on Multimedia, Hilton, Singapore, 2005, Pages: 181-190, ISBN:1-59593-044-2 Author: Steve Mann, Publisher ACM (Association of Computing Machinery) Press).

Multiple water-hammer instruments can be arranged in a two-dimensional array, or in a row, to control multiple multimedia events.

Some embodiments of the water-hammer instrument bear similarity to an electric guitar, in the sense that the sound is initially generated acoustically, and then there is electric processing, filtering, and amplification to increase the range of sounds but maintain a high degree of expressivity and intricacy of musical nuance that arises from the initially natural physical acoustic sound production. As with electric guitar, the new instrument of the invention can be used with numerous effects pedals, computerized effects, guitar synths, hyper instruments, and the like, while remaining very expressive. Particularly when playing the water-hammer piano underwater, at high sound levels, as with an electric guitar, feedback can be used creatively, to get long or infinite sustain in a way that is similar to the way in which notes can be held for much longer on an electric guitar than is possible with an acoustic guitar.

Some embodiments of the invention use one or more active “hydrospeakers” (transmit hydrophones, i.e. speakers designed for use underwater) built in, in addition to the “receive hydrophones” (underwater microphones) of the pickup. In much of the literature, the term “hydrophone” means a transducer that can send and receive, whereas similar transducers in air are described by the words “microphone” or “speaker” for receive and transmit, respectively. I prefer to use the term “hydrophone” to denote underwater listening transducers, and “hydrospeaker” to denote underwater sound-producing transducers, in order to disambiguate in applications where the device only sends or only receives.

The underwater hydraulophone with acoustic pickup is also useful for creative use of acoustic feedback, and various interesting forms of interaction with sounds produced in the water, especially if one or more hydrospeakers (“transmit hydrophones”) are installed inside the instrument.

In some embodiments the output from each microphone is run into a bandpass filter, tuned to the frequency of the note corresponding to that particular user interface port.

By cascading a variety of different filterbanks, some embodiments achieve a rich and full sound that is still very expressive, but is easier to play.

When using hydrophones to listen to the sound from inside the vibrating water, the hydrophone can dampen the sound, so it is best to use a hydrophone of low “dampiness”, i.e. a hydrophone that doesn't rob the instrument of too much sound. A piezoelectric cylinder encapsulated in a sufficiently rigid polymer will work. Preferably the polymer has an acoustic impedance similar to water, such that there is only one transition zone from into and out of the piezoelectric material. Alternatively, a graded-impedance layer of variously designed encapsulations, one on top of the other, may be used. In either case, loss should be avoided, and the wire to the hydrophone should also be selected so that its insulation is not acoustically lossy.

In some embodiments, to further increase the playability an acoustic exciter, such as one or more hydrospeakers, is placed inside the instrument, causing feedback to occur. When combined with a bank of bandpass filters, this results in a tendency for the instrument to favor playing at or near the center frequency of each bandpass filter. As a result of this feedback, the instrument becames alot easier to play “on key”, but still is sufficiently expressive (i.e. there is still sufficient ability to “bend” and sculpt notes).

In other embodiments a soundboard is used. The soundboard is connected to the reservoirs. For example, the reservoirs may each comprise an Erlenmeyer flask or flat-bottom bottle. A plastic folding table, such as the standard folding tables sold in home improvement centres, works quite well for this purpose. Bottles sitting on the table tend to radiate to the table's surface.

Alternatively, aluminum sounding plates may be TIG welded to the bottom of each of a plurality of aluminum bottles constructed from scrap aluminum fire extinguishers. The carbon dioxide and dry powder are emptied, and the empty canisters are modified into the desired size and shape. The sounding plates extend past the round bottoms of the variously modified fire extinguishers, and both radiate as well as absorb sound from the surrounding air, and conduct this sound into the bodies of the fire extinguisher metal, and subsequently the water contained therein.

The soundboard provides two useful functions: (1) it radiates sound from the vibrations in the chamber into the surrounding air; (2) it allows sound in the surrounding air to affect the vibrating water. This second use helps when trying to create acoustic feedback.

The meniscus of water rests statically or emerges slowly from each mouth, waiting to be struck by the palm or other body part such as the foot of the user (e.g. there can be hand division like the manuals of a pipe organ and foot division in ground nozzles like the pedal division of a pipe organ). This meniscusial user-interface allows the user to interact with water and abruptly set it into vibration.

### Specialized Embodiments of the Invention for Physiotherapy and Wellness:

The invention may be used for water therapy, as part of therapy pools, physiotherapy, music therapy and in health and wellness centres.

The invention may have a basin that captures and recirculates water emerging or gently brimming over each of the mouths.

The user of the invention may be seated in the basin, such as, for example, by making the basin be a hot tub or jacuzzi or therapy pool. One or more persons may communally enjoy being in the basin while one or more of the bathers use the apparatus of the invention.

The invention may be used for entertainment, relaxation, or training exercises, or the like, or in a spa or aquatics facility, waterpark, or playground for entertainment, relaxation, exercise, or training.

The invention may include an element for providing tactile stimulation. Such an element is sometimes referred to herein as a tactor. As used herein, a tactor is a type of transducer which converts an electrical signal to a variable tactile stimulation and which may also be capable of converting a tactile stimulation to an electrical signal. The tactor may be a vibratory transmit hydrophone in the water, or in each mouth of the instrument.

In some embodiments of the invention, brainwave entrainment may be used to create a relaxation or mediation environment. The tactor may vibrate in a repetition rate in the 1 to 30 CPS (Cycles Per Second) range. The actual frequency of vibration need not be in that range, but some aspect of the waveform such as the repetition rate of tone-bursts can be placed in that range for use in brainwave entrainment. A headband worn by the bather may thus be used to modulate the entrainment frequency of the device when used in these kinds of physiotherapy or the like.

More generally, brainwave entrainment need not be limited to sinusouidal signals of pure tone, but, may instead comprise spread spectrum excitation, or other arbitrary periodic or quasi-periodic signals that can be worked with the equivalent of a more generalized lock-in amplifier.

A standard lock-in amplifier such as a Stanford Research SR510 lock in amplifier can be used for sinusoidal signal detection. For example, we might excite the user at a particular frequency and then attempt to coherently detect the existence of that frequency in the subject's brainwaves. However, a better approach is to entrain desired brainwave activity more generally, with an arbitrary periodic excitation, and then measure, more generally, the response to this very excitation, with signal averaging, or the like.

Tactile and audiovisual entrainment, biofeedback, or the like, are constructed such that thalmic stimulation of the cerebral cortex affects cortical activity, in a frequency range around 1 to 30 CPS over a large area of the body such as by vibratory elements or other tactuators in, seating, pulsating hot tub jets, as well as audiovisual stimulus.

Television can have a sort of hypnotic effect on the watcher, thus causing different brain states to be reached. Similarly, a computer screen can be directed in a more structured way, as part of a biofeedback loop, especially in the context of a relaxation tub, relaxation application, or for exercises for the mind and body.

Various forms of SSVEP (Steady State Visual Evoked Potentials may be displayed on a multimedia display device, or, alternatively, upon illumination sources in the finger or hand holes of the instrument, by way of illuminating each of the water holes separately. In this way, one or more senses can be stimulated for brainwave entrainment while part of an exercise or game or training or relaxation regimen is in process.

Some embodiments of the invention may use tactile sound, so that the device is more than simply an input device.

Frequencies up to a couple hundred CPS may be felt by the fingers if sufficiently strong in their vibrations, as can be achieved by way of, for example, a suitable tactuator such as the Clark Synthesis AQ339 geophone or hydrophone sometimes referred to as an “Aquasonic Underwater Speaker”, although it is more of a geophonic or hydrophonic device than a loudspeaker (i.e. it is meant to move solid matter or liquid matter more so than to move air).

In applications where the use is not underwater, but outdoors in light rain, or in a somewhat dry housing, a Clark Synthesis model AW339 will suffice.

The result is “tactile sound”, i.e. a sensation of sound sent to the human body directly in liquid or solid matter, rather than through air.

In communal bathing areas like one might find at a place like Spaworld USA, the “tactile sound” can be felt without too much disturbance to other bathers using adjacent therapy equipment.

In a hot tub, even a communal hot tub or spa, tactual vibration of one individual's body can be achieved without too much disturbance to others, if desired.

### Baseband Versus Narrowband Sensing:

A simple embodiment of the invention comprises a row of a dozen or so bottles that are filled with water, by a source that slowly fills each bottle and thus makes all the bottles gently runneth over. Each bottle has a hydrophone, such as a Sensortech model SQ34, in the bulb part of the bottle. Each hydrophone is connected to an amplifier input, whereupon the instrument is played by striking or tapping the open mouths of the bottles to make a nice pure sound which sounds similar to that made by a Fender Rhodes electric piano (i.e. similar to the sound made by striking a tuning fork tuned to each note). The sound is very pure because the bottles form Helmholtz resonators that each tune to one and only one frequency with very little in the way of overtones or higher harmonics beyond the fundamental.

The best way to play the instrument is to strike the meniscus of the water. This meniscusial user-interface allows for a great deal of nuance. Additionally, the instrument can be played by tapping the edges of the necks of the bottles, with the fingertips, in a downward motion.

An alternative form of listening device is a pressure sensor or diaphragm sensor, such as made from a piezoresistive diaphragm having a Wheatstone bridge, supplied with a power source such as, for example, a 12 volt power supply. Preferably the 12 volt supply is center-grounded, with +6 volts going to one side of the bridge input and −6 volts to the other. The bridge output is connected to a balanced XLR microphone plug (Switchcraft A3M) or a balanced quarter inch plug, or an underwater connector. Such a pressure sensor or diaphragm sensor is placed such that one side of each diaphragm listens inside each bottle, and the other side is referenced to atmosphere. In this way, the sound can be heard all the way down to, and including a frequency of 0 CPS, i.e. DC (Direct Current).

This combined “AC DC” capability means that the sensor can hear the bell-like sound of striking the water, as well as feel the sustained pressure if exerted in a sustained manner. The sensed pressure can be frequency-shifted to match the resonance of the bottle, and in this way, hitting the water makes a chime, and pressing and holding down on the water makes an organ sound.

Since the diagphragm sensor can listen to AC and DC, the result is a “PIANOrgan” (a portmanteau of the words “piano” and “organ”), or “guiolin” (a “guitar” and “organ”).

The low-frequency sensing that goes right down to 0 CPS is called baseband sensing, and the resulting signal is called a baseband signal. It is generated by pressing the palm down on the mouths of one of the bottles and holding it down. As long as you keep it held down, the pressure in the bottle remains higher than it was before, and the pressure sensor continues to output DC.

The sound made by striking without pressing is an AC signal that is called a passband or narrowband signal.

Combining the narrowband and baseband signals can work with the bottles when fitted with a diaphragm sensor that does double duty listening to the AC and DC signals.

Alternatively, since many diaphragm sensors are not very sensitive, or of limited dynamage range (i.e. are damaged by heavy water hammer if they are made to sensitive), it may be preferable to use one sensor for the AC and one for DC and thus have a small-signal sensor and a large-signal sensor. A suitable DC large-signal sensor is a diaphragm sensor or pressure sensor such as is commonly used in process control systems. A suitable AC small-signal sensor is a Sensortech model SQ34 hydrophone. Together these two sensors, one for each bottle, will give a better result than using the diaphragm sensor alone.

When using bottles, the elasticity arises from the large volume of water, and water being slightly compressible yields when presented in a sufficiently voluminous reservoir. The bottle's own elasticity may or may not also contribute, depending on the wall thickness of the bottle (for example, encasing the bottles in cement makes them follow theory better, and thus easier to compute using the standard Helmholtz formula). Additionally, backing the bottles in cement helps prevent them from breaking due to excess forces and transient forces. One embodiment uses variously sized Bordeaux wine bottles or Florence flasks encased completely in cement, except for the mouths of the bottles, each bottle having two additional holes, one for a continuous water supply, and another for a listening device to listen to the vibrations in the water itself. The Bordeaux wine bottles, or Florence flasks, or the like, may be cut to different lengths using a bottle cutter, and then welded together using glass working techniques.

Wine bottle cutters are well known in the art. More durable bottles can be made from stainless steel spheres TIG welded to stainless steel pipes. An easy way to get stainless steel spheres is to obtain floats made out of stainless steel. These spherical floats are readily available, and can be TIG welded to a stainless steel pipe, after knocking a hole in the sphere using a plasma cutter. A suitable process for manufacturing the hydraulophone bottle is to use a plasma cutter, such as Miller Spectrum 375 X-TREME™, to cut a hole in a stainless steel float. A suitable size of float is one that is in the 3 inch (approx. 75 mm) to 9 inch (approx. 230 mm) diameter range. A pipe is then TIG welded onto the ball to make a hydraulophone bottle. A satisfactory welding process is the use of a Miller Dynasty 350 that has been modified from the standard 14 pin control connector to the 28 pin welding automation connector, for use with a robotic orbital welder, to automate the process of TIG welding the pipes onto the balls. A weld current is delivered at high amperage and low frequency while a 2% Thorium tungsten electrode moves toward the pipe, and the weld current is reduced and the frequency is increased while the electrode moves toward the float, which is typically of thinner material.

A satisfactory size pipe is a schedule 40, size 6 (1 inch nominal, approx. 25.4 mm nominal, having approximately 1.315 inch outside diameter) pipe for some of the medium notes on the instrument. A size 7 or 8 pipe is suitable for the lower notes, and a size 5 (this is called “three quarter inch pipe” and is approximately 1.05 inches or 26.7 mm outside diameter) is suitable for the higher notes.

Alternatively, instead of using bottles for the hydraulophone pipes, the hydraulophone pipes may each be made from a rigid pipe fitted with an elastic end medium on the bottom of each pipe. A satisfactory elastic medium is the diaphragm from a Sloan Valve model LC (which stands for “Low Consumption”) flushometer. Thus a very nice waterhammer piano may be constructed from a dozen or so Sloan Valve LC flushometer diaphragms fitted onto the bottoms of pipes of various lengths, the lengths determining the notes of each of these hydraulophone pipes.

Instead of using the flushometer diaphragms, a thin stainless steel “bender” may be TIG welded to the bottom of each of a plurality of stainless steel pipes to get the elastic medium.

A simple variation of this embodiment arises by way of using a piezoelectric “bender” transducer as the end cap for the bottoms of each of the pipes. In this way the bender does double-duty as both a spring and a sensor.

Alternatively, some kind of strain gauge may be affixed to each pipe bottom. Thus the pipe bottoms themselves become diaphragm sensors.

Suppose each of a dozen pipes is fitted with a strain gauge resistance bridge, at its bottommost point. One input to each bridge is supplied with a voltage supply such as +6 volts, for example, and the other side with −6 volts. The dozen or so pairs of outputs are connected to instrumentation amplifiers that can listen to the sounds of the vibrating water as well as listen to the baseband pressure if, for example, pressing and holding the palm of the hand onto the mouth of the hydraulophone pipe.

Alternatively The dozen or so bridges can be matrixed in a 3 by 4 arrangement, to use 3 of the 6 analog inputs of an Atmel ATMEGA48 for example. The bridges are supplied by voltage from output pins PB1, PB2, PB3, and PB4 of the ATMEGA 48, as referred to the Atmel ATMEGA 48 datasheet, or the pinout diagram, which can be obtained from Atmel Corporation or there is also a local cache in http://wearcam.org/ece385/avr/.

Were more tactors are present, we simply use more pins, e.g. PB0-7 driving a 6 by 8 set of matrixed bridges into all six analog inputs provides 48 bridges, so that we can then have 48 hydraulophone pipes, i.e. 48 water holes, analogous to a piano with 48 keys.

The output of each of the 12 bridges (one for each water hole) may be connected directly to pins PC0-PC2 (refer again to Atmel ATMEGA 48 datasheet for PC0, PC1, PC2, etc., pinout designators), for simplicity.

Preferably, though, we connect the two outputs of each bridge (i.e. left and right) to a differential instrument op amp (operational amplifier) and the output of that op amp is what is actually connected to the input pins PC0-2. Because of the matrixing, for the 12 diaphragm sensors, we only require 3 op amps for 12 sensors, rather than requiring 12 op amps.

Pressing the palm and holding down on one of the water holes decreases the resistance of one path of the bridge (i.e. increases the conductivity, of one path of the bridge thus pulling the output voltage of the bridge in one direction. The bridges are normally wired so that this direction results in more positive output of the positive output of the bridge with the other side going more negative, such that a differential op amp connected to the bridge output gives a higher output.

Thus pressing down on one water hole causes a measurable output for that particular corresponding bridge, that indicates pressure. Resistance bridges are in some ways analogous to a carbon microphone, and can “hear” sounds and other disturbances made in the water, in addition to slow flexing. Thus the bridges pick up a frequency range that goes all the way down to 0 CPS, i.e. Direct Current (DC). In this sense, the sound spectrum that the bridges “hear” includes the origin, in the frequency axis.

In addition to flexion, in some embodiments, we have one or more AC hydrophones in each pipe that listen to vibrations in the water. AC hydrophones such as the Sensortech SQ34 tend to pick up higher frequencies better, and they can also “listen” and “speak”, i.e. they can create disturbances when fed with electric input. Another suitable hydrophone is the previously mentioned Clark Synthesis AQ339 geophone or hydrophone.

Hydraulophones that can be Played Underwater or Above Water:

One of the problems I've always had with hydraulophones is that if I tune an instrument for use in open-air, it goes out of tune when underwater.

Conversely, if I tune it for use underwater, then it is not in tune when it is above the surface of the water.

This is mainly due to the extra “effective length” of the hydraulophone pipes when underwater. The change in eLasticity of the hoses or tubing due to being underwater has a lesser effect (e.g. the water affects the pipes more than the tubes). When the lactic member is a bulb, the water “stiffens” the bulb contributing to a slight increase in pitch, but this change may be less significant than the change in effective neck length (depending on the wall thickness of the bulb, etc.).

As an example of the problem, consider the easy-build hydraulophone like the ones I used to make from surplus hoses (hereafter referred to as “tubing”) and toilet tubing (hereafter referred to as “pipes”), in which the 12 tubes are of equal length and the 12 pipes are of tuned (varying) length (i.e. cut-to-length in the tuning process), and in which all 12 tubes are of one diameter, say dₜ, and all 12 pipes are of another diameter dₚ.

In this instrument the main tuning is done by pipe cutting, and the fine tuning by tube-cutting, but let's say, for simplicity that the tubes are all equal length lₜ, and the pipes are various lengths, lₚ₁, lₚ₂, lₚ₃, etc. For simplicity in the notation, let's call these pipe lengths l₁, l₂, l₃, . . . , etc., and use the letter “d” to denote the diameter of the pipes dₚ.

Underwater, the pipes are effectively a little longer than their true length. The increase in effective length turns out to be about 0.6 times the diameter in extra effective length (empirical finding). Thus the effective lengths are: l₁+0.6d, l₂+0.6d, l₃+0.6d, etc.

The tuning problem arises because the effective length of about 0.6 times the diameter, ADDED onto the length of every pipe.

The true lengths of the pipes vary geometrically (exponentially to generate a logarithmic frequency spacing) but the added length is an arithmetic constant added to each length.

Thus the whole instrument goes out-of-tune even with itself, when the surrounding medium (air or water) is not the same as the medium in which the instrument was tuned at time of manufacture.

Some embodiments of the hydraulophone invention make the following improvement: The diameters of the pipes is varied, such that the lower notes use larger pipes and the higher notes use smaller pipes. The size is graded in such a way that the result is a geometric increase in effective pipe length when underwater rather than the arithmetic increase in effective length.

To understand this, let us consider the ideal (conceptual) hydraulophone. The ideal hydraulophone is one in which the tubes are replaced with inelastic containers that hold enough water to get the eLasticity from the water itself rather than from the tubes.

The ideal hydraulophone can be approximated by an hydraulophone encapsulated in concrete, such that there is very little eLasticity in any of the parts of the hydraulophone.

In this case, the tubes are replaced by water reservoirs, spherical for simplicity, which are simply spherical voids in the concrete.

The effective length of the pipes when the entire instrument is underwater is given by lₑ=l+0.6r+8r/(3π), which works out to about 72.44% of the inside diameter of the hydraulophone pipe.

When operated above the surface of the water, the effective length is given by lₑ=l+8r/(3π), since the effective length extension of the open end of the hydraulophone pipe (the user-interface end) is negligible (the water medium ends abruptly at the finger hole and no longer extends into open space).

Consider two notes on the hydraulophone, the notes being of frequencies f₁ and f₂.

These frequencies may be approximated by:

$$\begin{matrix}{f}_{1} = \frac{c}{2 π} \sqrt{\frac{{A}_{1}}{{V}_{1} {l}_{1}}} & ( 1 ) \\ {f}_{2} = \frac{c}{2 π} \sqrt{\frac{{A}_{2}}{{V}_{2} {l}_{2}}} , & ( 2 )\end{matrix}$$

where c is the speed of sound in water, Aᵢ are the inside cross sectional areas of the pipes, Vᵢ are the effective volumes of the lactic media (tubes or bulbs or the like), lᵢ are the lengths of the pipes, and i=1 or 2.

Therefore this embodiment of the invention is given by choosing the diameters and lengths such that the ratio of f₁ to f₂ is the same underwater as it is above water, i.e. such that adding or subtracting 0.6 times the radii to the lengths leaves the ratio f₁/f₂ the same underwater as it is above the water.

More generally, we choose the pipe diameters and lengths such that fₘ/fₙ is maintained constant regardless of whether we are above or below water, for any randomly selected pair of hydraulophone pipes m and n.

The result is that the diameters of the pipes must be such as to start with large finger holes for the lower notes (longer pipes) and small finger holes for the higher notes (shorter pipes).

In practice, this is achieved to within a small degree of approximation, but limited by the fact that pipes only come in certain quantized diameters.

However, to maintain good quality tuning below and above the water surface requires the making of pipes of continuously varying diameters as with a church organ where each pipe is made-to-measure rather than being selected from a discrete “alphabet” of standard pipe sizes.

To the extent that many of these tradeoffs are approximations, another useful constraint is to chose lengths and diameters such that the instrument goes flat by an integer number of semitones when placed underwater.

Thus, for example, in some embodiments of the invention, an A-minor hydraulophone becomes an A-flat-minor hydraulophone when played underwater. If it is a chromatic hydraulophone, this simply results in a shift-by-one of the finger holes. Thus it can still be accompanied by other instruments during a performance in which it moves from being above the water to being underwater without the need for the other instruments (e.g. violins, cellos, piano, etc.) to be re-tuned during the transition of the hydraulophone from above water to underwater.

This can work to dramatic effect as the instrument sounds sadder and darker and deeper as it is lowered into the water.

The instrument can also be constructed such that the sharpening due to encapsulation in concrete is a musical interval.

For example, in some embodiments, hydraulophones, and in particular their Nessonators™, are constructed so that they go up exactly a perfect fifth when encapsulated in cement.

The words Nessonator, Nessonance, and Nessonate are trademarks, which define resonators, resonance, and the capacity to resonate, by non-aerophonic and non-idiophonic means. In particular, Nessonance denotes vibrations in liquid media. This terminology is used in the scientific literature; see for example: “User-Interfaces Based on the Water-Hammer Effect: Water-Hammer Piano as an Interactive Percussion Surface”, by Steve Mann et al., in Proceedings of the fifth international conference on Tangible, embedded, and embodied interaction (TEI), Funchal, Portugal, 23-26 Jan. 2011, pp. 1-8 (first paper in the proceedings), ACM (Association of Computing Machinery, ISBN: 978-1-4503-0478-8.

When thin-walled Nessonators are encapsulated the Nessonant frequency typically increases, and this increase can be controlled by careful design. Thus, for example, an A-minor hydraulophone becomes an E-minor hydraulophone when filled with cement.

Alternative embodiments use metamaterials that temporarily solidify and unsolidify, to “repitch” a hydraulophone reversibly.

### Hydraulophones and Forestry:

Some wind instruments, such as flutes, are referred to as “woodwind” instruments regardless of the material from which they are made. Likewise I use the term “woodwater” instruments to denote certain hydraulophones, regardless of the material from which they are made.

Part of my reason for inventing the hydraulophone, and giving water a “voice” (e.g. the first time in human history that the world has been able to hear “the voice of water”) is to raise social awareness of the importance of clean lakes and rivers, and of our watersheds, and of our natural world.

People of the First Nations often refer to water as the “life blood of the earth” or the “life blood of the forest”. Accordingly I propose a form of hydraulophone concert that engages the three states-of-matter, i.e. Earth (solid matter), Water (liquid matter), and Air (gaseous matter), as follows:
a forest is selected, perhaps with a natural body of water;
Earth instruments (e.g. instruments that make sound from vibrating solid matter, e.g. Native Drums) are positioned near the ground;
Water instruments (hydraulophones) are positioned on or in the water (a natural body of water in the forest or a temporarily installed body of water);
Air instruments are positioned up in the air, e.g. on a forest canopy walk.

Various other related works are possible. For example, an andantephone may be placed in the forest, using geophones to pickup siesmic waves in the ground and render as sound output to accompany the hydraulophone.

Alternatively a geophonic accompaniment of “smart shoes” may be used. In one embodiment of the smart shoes, they are constructed as platform shoes that are hollow inside, with a downward-facing camera that captures an image of the ground or earth or floor that comprises the shoe's footprint area. Each shoe also contains accelerometers, electronic compass, inertial guidance system, and GPS, so the shoes “paint” out a map as the wearer walks around. Walking back and forth to a specific location the earth is eventually photographed more densely. If a section of floor or earth is covered completely with these “earthprints” a complete picture of it is obtained. This performance piece is called “Earthprints: Ecological Footprints and impact assessment” as it relates to our footprint especially in forests and other areas that are sensitive to human foot traffic. The shoes also contain geophones that measure seismic waves of one's own footsteps to calculate impact and soil compaction.

The philosophical message is that we need to tread lightly to have a lesser impact on our environment.

### Terminology:

It is helpful to classify transducers according to state-of-matter in which they operate:

solid: geophone;

liquid: hydrophone;

gas: loudspeaker or microphone;

plasma: ionophone.

### BRIEF DESCRIPTION OF THE DRAWINGS

The invention will now be described in more detail, by way of examples which in no way are meant to limit the scope of the invention, but, rather, these examples will serve to illustrate the invention with reference to the accompanying drawings, in which:

FIG. 1A illustrates an embodiment of the invention having a plurality of elastic bulbs, each connected to a rigid pipe.

FIG. 1B illustrates an embodiment of the invention having oil-filled hydraulophone pipes with the hydraulic fluid fully sealed inside.

FIG. 1C illustrates an embodiment of the invention having a sounding board and waterkeeper.

FIG. 1D illustrates an embodiment of the invention having the hydraulophone pipes and their bulbs mounted above-deck.

FIG. 1E illustrates an embodiment of the invention having a pitch-bend pedal.

FIG. 1F illustrates details of a bulb in an embodiment of the invention that has elastic bulbs, as well as Neckstention™ neck extensions that also secure the upper soundboard in an above-deck double-soundboard embodiment of the invention.

FIG. 1G illustrates an embodiment of the invention having a labium or labia and fipple mechanism in order to sustain steady-state Nessonance™.

FIG. 1H illustrates an embodiment of the invention having a basin, heater, and recirculating pump, suitable for being, or being installed in, a hot tub, or the like.

FIG. 2 illustrates a bottle piano embodiment of the invention.

FIG. 3 illustrates an AC, DC (Alternating Current, Direct Current) embodiment of the invention in which subsonic (or DC) sounds in a bottle are used to modify the audible sounds in the bottle.

FIG. 4 illustrates a bottle piano embodiment of the invention setup with 12 bottles on a musical scale.

FIG. 5 illustrates a tuning method for the bottle piano embodiment.

FIG. 6 illustrates an embodiment having closely spaced mouths.

FIG. 7 illustrates an embodiment where the DC channel is implemented by a fipple circuit that is completed by the touch of a finger or the like, to a playing interface.

FIG. 8 illustrates an AC/DC arrangement by way of analogy to

FIG. 9 illustrates an embodiment of the invention that uses a shifterbank to eliminate the need for the different bottle sizes, or the need for bottles altogether.

### DETAILED DESCRIPTION OF THE PREFERRED EMBODIMENTS

While the invention shall now be described with reference to the preferred embodiments shown in the drawings, it should be understood that the intention is not to limit the invention only to the particular embodiments shown but rather to cover all alterations, modifications and equivalent arrangements possible within the scope of appended claims.

In various aspects of the present invention, references to “microphone” can mean any device or collection of devices capable of determining pressure, or changes in pressure, or flow, or changes in flow, in any medium.

Likewise the term “hydrophone” describes any of a variety of pressure transducers, pressure sensors, or flow sensors that convert changes in hydraulic pressure or flow to electrical signals. Hydrophones may include differential pressure sensors, as well as pressure sensors that measure gauge pressure. Thus a hydrophone may have a single “listening” port or dual ports, one on each side of a glass or ceramic plate, stainless steel diaphragm, or the like. The term “hydrophone” may also include pressure sensors that respond only to discrete changes in pressure, such as a pressure switch which may be regarded as a 1-bit hydrophone. Moreover, the term “hydrophone” can also describe devices that only respond to changes in pressure or pressure difference, i.e. to devices that cannot convey a static pressure or static pressure differences. More particularly, the term “hydrophone” is used to describe pressure sensors that sense pressure or pressure changes in any frequency range whether or not the frequency range is within the range of human hearing, or subsonic (including all the way down to zero cycles per second) or ultrasonic. Similarly the term “geophone” is used to describe any kind of “contact microphone” or similar transducer that senses or can sense vibrations or pressure or pressure changes in solid matter. Thus the term “geophone” describes contact microphones that work in audible frequency ranges as well as other pressure sensors that work in any frequency range, not just audible frequencies.

The terms “Earth”, “Water”, “Air” and “Fire” refer to the states-of-matter. For example, the Classical Element indicated by the term “earth” refers to any solid matter. Likewise the term “water” refers to any liquid such as wine, oil, hydraulic fluid, or the like. The term “hydraulic” also refers broadly to any pressurized or pressurizable liquid not just water. The Classical Element of “air” likewise refers to any gas, etc.

When I refer to a rigid pipe, I mean that the pipe need not be non-rigid, i.e. if the pipe is non-rigid it still falls within the scope of the invention. For example, in a bottle embodiment of the invention, it is preferable that the pipe be rigid and that the bulb be either rigid or non-rigid. However, the invention can still be practiced with a less rigid neck, and it will still work, to some degree.

Moreover, there need not be a clean boundary between neck and pipe. The neck of a bottle is the pipe in some embodiments. In other embodiments the neck of the bottle is connected to a pipe, which serves as a neck extension, i.e. a Neckstention™, or just simply a situation in which part of the neck is a bottle, and part of it is a separate removable pipe. Likewise the bulb may have part of the neck attached to it. For example, if the bulb is a spherical Coca Cola™ bottle as are commonly sold, filled with Coca Cola, also known as Coke™, from December 1st to late December each year in North America, part or all of the neck is formed as part of the Coke bottle itself. The invention may, but need not necessarily, include an additional neck extension. Thus whether or not the neck extension is present, an hydraulophone of this type will still fall within the scope of my invention.

The method claim(s) is/are meant to be taken in the broad sense, e.g. a method of making music with water by filling bottles and then putting a listening device inside each bottle, or coupling an acoustic soundboard or the like, to one or more bottles, is to be taken as the same method as putting the listening device in first and then filling up the bottles.

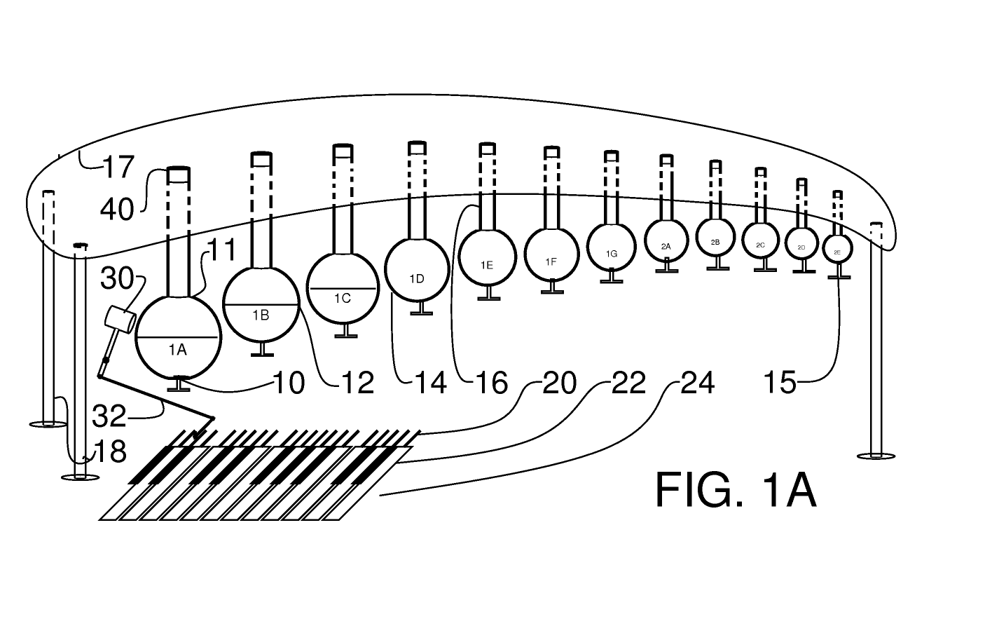

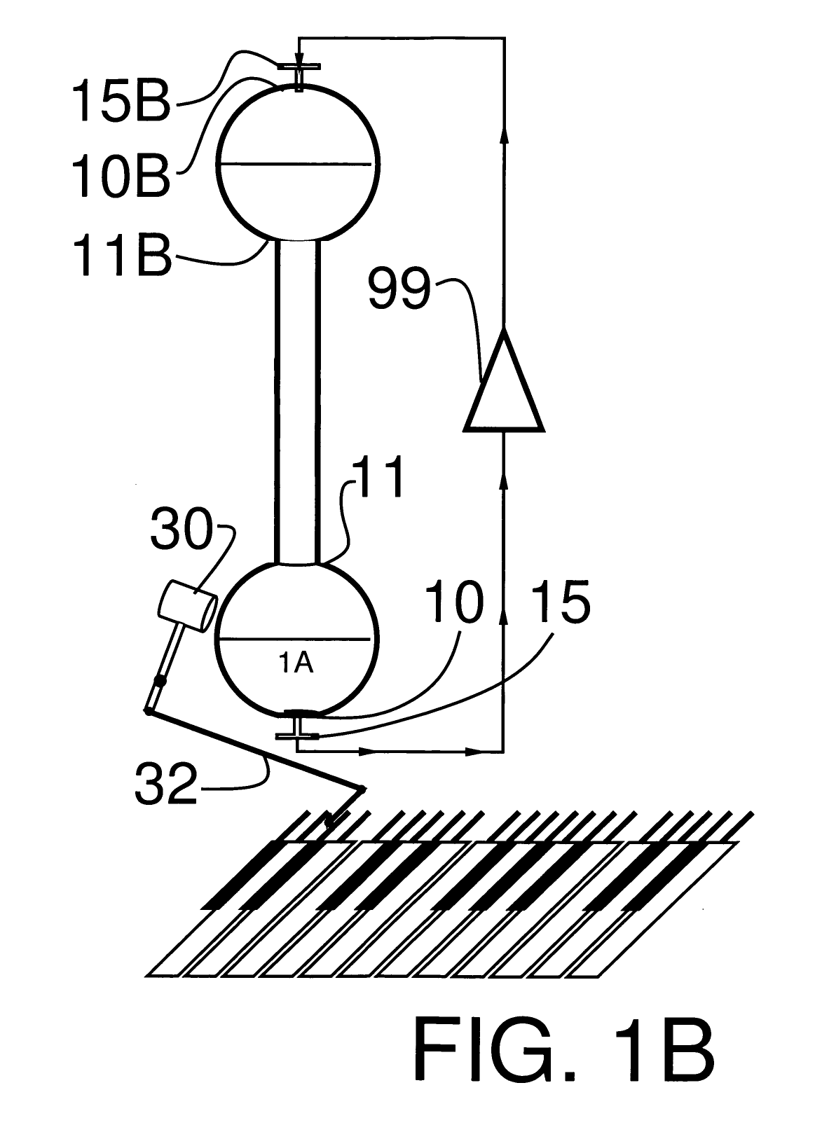

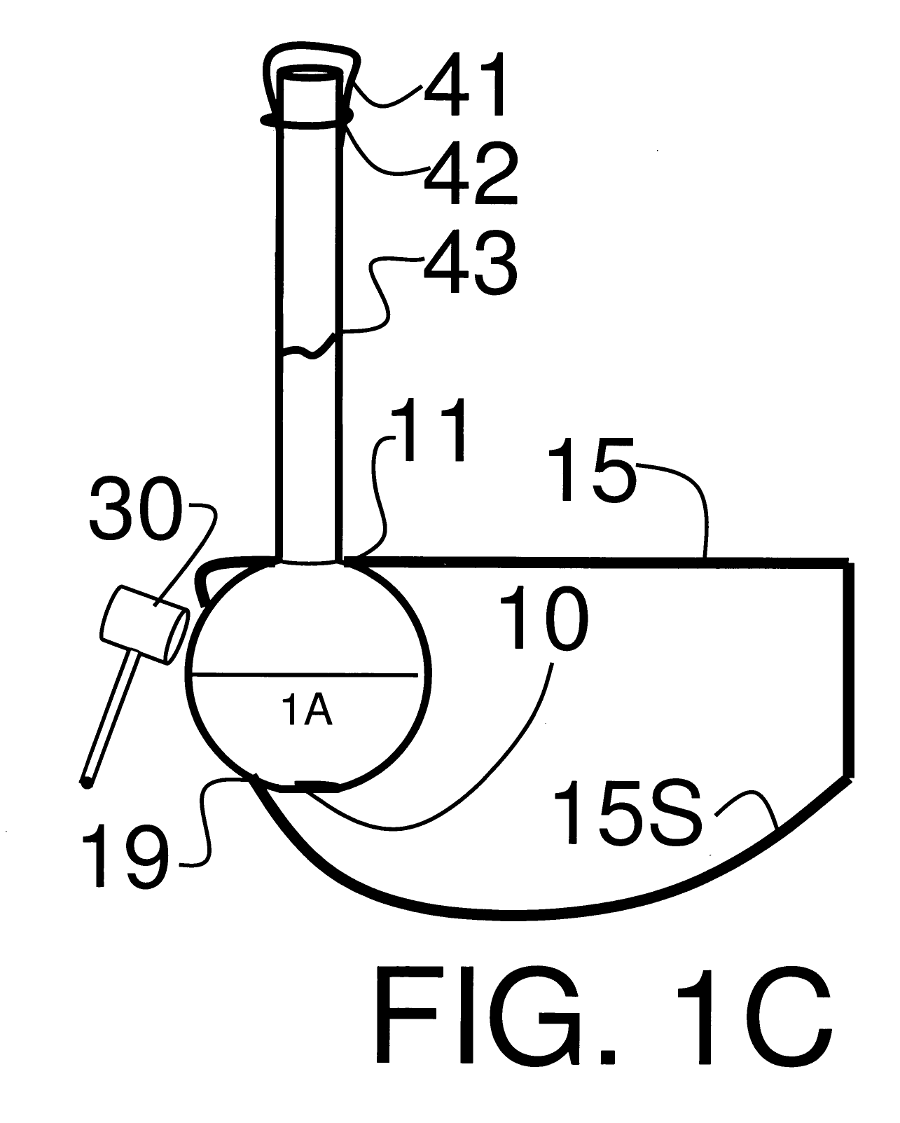

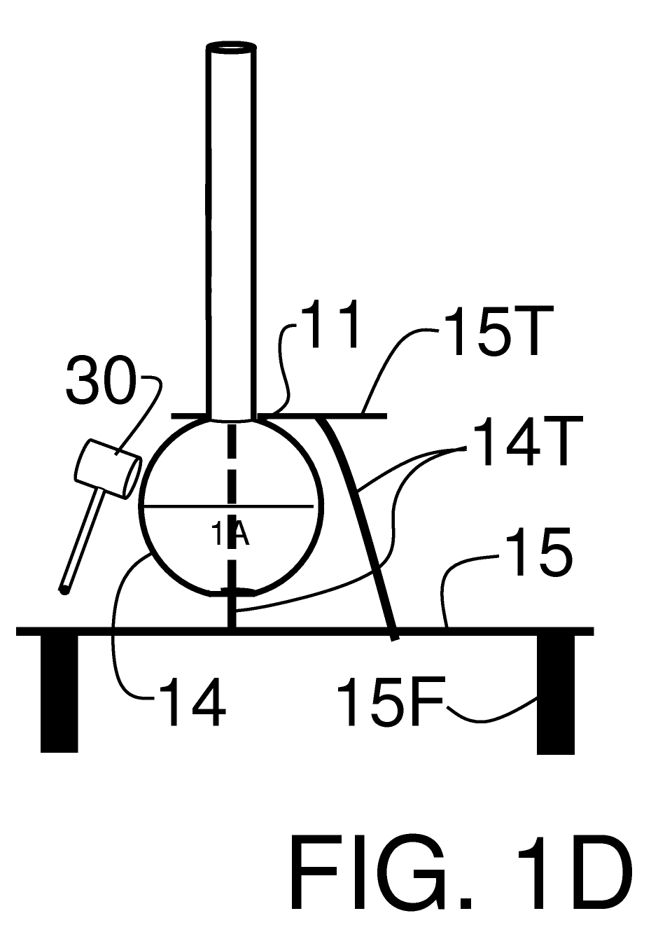

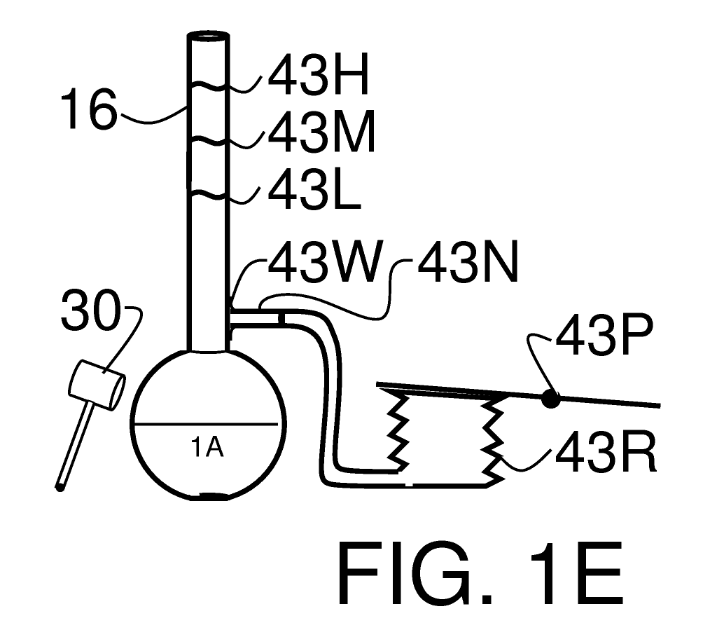

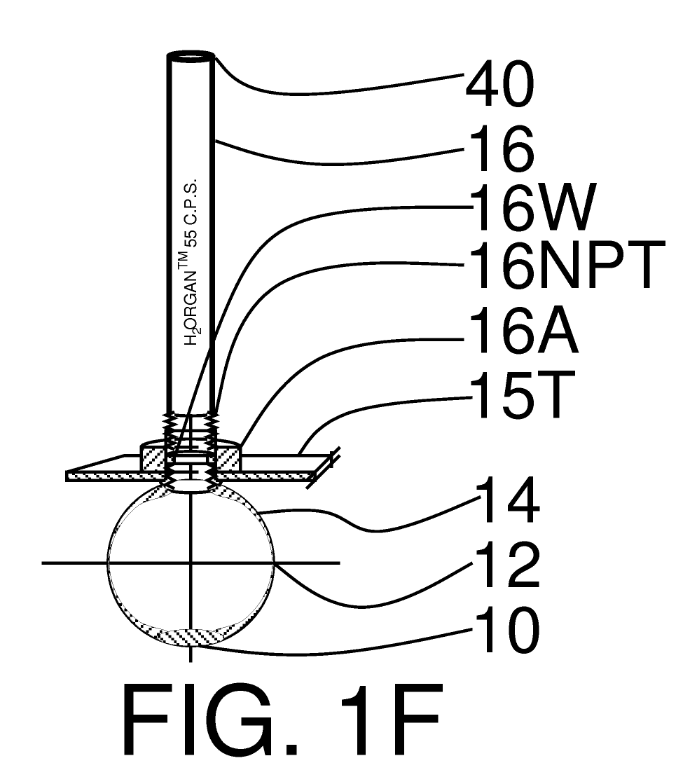

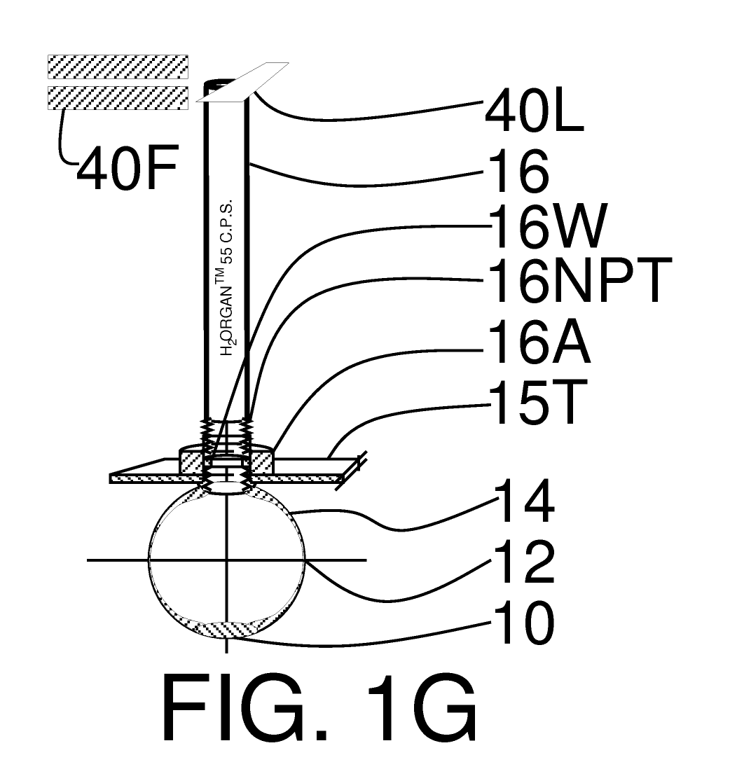

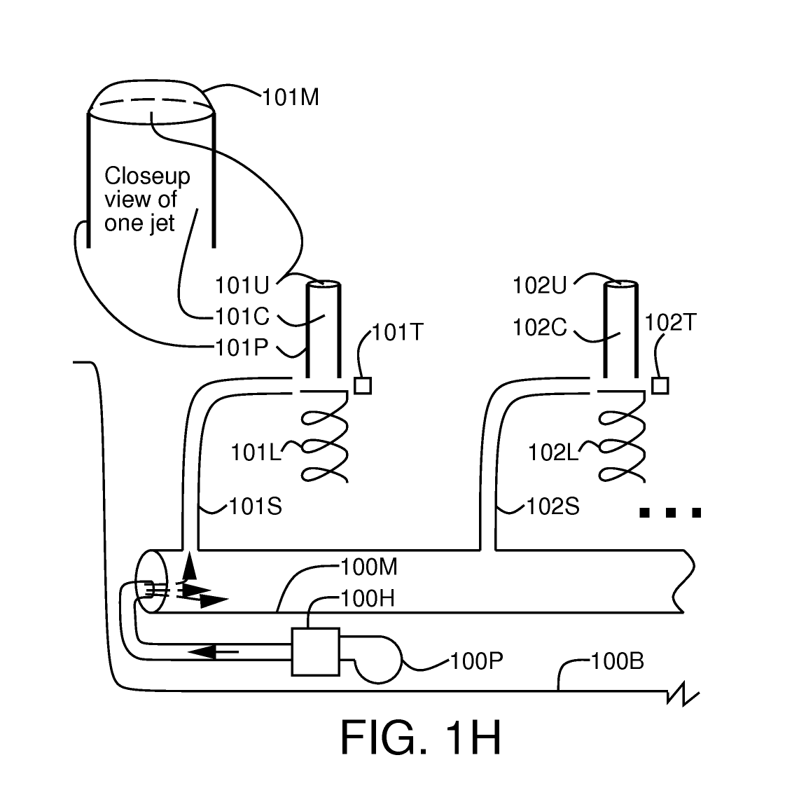

FIG. 1A illustrates an embodiment of the invention having a plurality of bottles 14 that are constructed from rigid necks 16 operably connected with bulbs 14. Water in the neck vibrates as a mass, and the bulb forms a spring, either by its massive volume, or its elasticity. The neck 16 is rigid, but the bulb 14 can be either elastic or ridid. Each neck with bulb with water inside it resonates at a specific frequency that forms a musical note on a musical scale. The player can change the pitch at will, by sticking his or her finger into the finger holes 40, to get rid of some water (reduce the water level so that the neck 16 is only partially filled) and then playing a note, or by leaving the finger in the neck to restrict its size. Water can be splashed out, our poured back in, even while playing a note, so that the note “chirps” (changes pitch while sounding). This can give the music a very “watery” sound.

Other manipulations are possible so that a wide variety of sounds and expressions can be made. For example, the player can spray water across the mouths of the bottles through a narrow slot (fipple, or the like) against a labium, or one or more labia, or other lip or edge, in order to make a steady long drawn out note of unlimited note duration.

For the moment, let us consider an embodiment in which the bulbs are elastic. Each bulb is made of an elastic material in such a way that it either has only one dominant mode of vibration or it has a plurality of modes that resonate in a consonant manner (e.g. having resonant frequencies in the ratio of small whole numbers).

A satisfactory material for the bulbs is PETE (polyethylene terephthalate), also known as PET. Preferably the bulbs are somewhat spherical or globe-shaped. The bottles may be blown, so as to have a thick bottom, and a thick top. A top region 11, analogous to the area around the North Pole of the globe, includes a build-in neck, or a connector for a neck, i.e. the ConNECKtor™. Top region 11, for example, may include or be a threaded portion such as one might find on the top of a soft drink bottle.

A bottom region 10, analogous to the area around the South Pole of the globe, is thick like the top. Thus the globe is somewhat symmetric in its modes of vibration, about a central equatorial region 12.

The instrument may be played by striking water openings, or finger holes 40 at the ends of the necks 16 that are not connected to the bulbs 14. This sets the water in vibration. Alternatively, the instrument may be played by tapping on the bulbs 14 with the fingers. This also sets the water in vibration.

The instrument tends to sound best when the globes are struck slightly North of the equator. Accordingly a hammer 30 can strike the globe by way of a linkage 32 to a keyboard 24. Pressing a key 24 pulls on a linkage that causes the globe to be struck. Each key 24 activates a hammer 30 associated with each bulb 14.

In this description I use some terms interchangeably, e.g. “globe” and “bulb”, where the term “globe” is used as an analogy to places like North Pole, South Pole, and equator.

When the bulbs 14 are being struck by hand, they may preferably be arranged in a circle, semicircle, arc, or curve, by way of a bottle stand and frame or housing or support, such as support 17. held in place by a stand with legs 18.

In some embodiments each bottle bottom has a reproducer or soundbox or acoustic impedance matcher or pickup or sensor, or the like, which I will call a “transformer”, denoted by transformer 15.

A satisfactory transformer is the “SoundBox” from an RCA Victrola™ or HMV (His Master's Voice™) gramophone player connected to a horn, or a “Reproducer” from an Edison wax-cylinder player. These devices contain no electric components, and thus the resulting completed hydraulophone is entirely acoustic, and entirely human-powered, having no electrical components in it, not even a motor.

However, each transformer 15 may also be an electric pickup on the bottom of each bulb, or elsewhere on the resulting bottle (e.g. in the neck 16). In embodiments with Southern pickups (pickups located at the “Antarctic” region of the globes), the transformers 15 are each located on the bottom of bulb 14.

Alternatively, instead of electric amplification, a compressed-air amplifier such as that found in an Auxetophone or other compressed-air gramophone, may be used. Thus hydraulophones having no electrical components can be used in large concert venues.

Transformers 15 can also take the form of sounding boards made of carbon fiber, nano-materials, or biomaterials, like the wooden soundboard of a cello, but more resistant to water.

The various notes are denoted on the bulbs in Hydraulophone Pitch Notation, as 1A, 1B, 1C, 1D, 1E, 1F, 1G, 2a, 2b, 2c, 2d, and 2e, showing only some of the whole notes (the sharps and flats are omitted for clarity to keep the drawing uncluttered, and also some models come without sharps or flats, there being a customer choice between diatonic and chromatic hydraulophones).

The embodiments of hydraulophone depicted in FIG. 1A involve working with the 3 states-of-matter to get the sound nice. Liquid vibrates up and down in each neck 16, causing each of the bulbs 14 to vibrate. The vibrations in the solid matter of the bulbs are conveyed to the surrounding air by way of transformers 15.

The lower notes can be made from larger bulbs, bulbs having lesser wall thickness or of less stiff material, longer necks, and necks having smaller diameters, or any combination of these.

The bulbs are often more fragile than the necks, so if the instrument is being installed as public art or in a playground in a rough neighbourhood, there may also be a housing around each bulb or around all the bulbs, or the like, to protect them from vandalism or carelessness.

But in a concert instrument, most musicians prefer direct access to the bulbs rather than the use of a keyboard, as direct access improves musical expression. If bulbs are damaged, it is preferable not to require an inventory of many different sized replacement bulbs. Accordingly, a single sized bulb, in conjunction with varying neck lengths, is preferable. A satisfactory bulb is the spherical soft drink bottles sold by Coca Cola™ at Christmas time. These bulbs come filled with Coca Cola and resemble Christmas decorations. The Coca Cola printing comes on a skin that can be removed to reveal a clear plastic spherical bottle. Removal of the skin helps make it easier to see into the bottle, and detect any foreign particles that might be collecting therein. Typically removal of the skin lowers the pitch, e.g. a 3.5 inch neck needs to be shortened to approximately 3 inches to maintain the same pitch when the skin is removed.

Thus using Coke Spheres for bulbs 14 provides a low-cost solution to bulb replacement. Necks 16 are made from ¾ inch Schedule 40 pipe, which has about the same inside diameter as the Coke Sphere's neck's inside diameter. Typically the necks 16 are cut to various lengths and threaded at both ends with a 14 TPI (Threads Per Inch) pipe thread. Then adapters are made to connect these varying length ¾ inch pipe nipples to the bulbs. An O-ring having a rectangular cross section is used to seal each neck to the corresponding bulb.

Coke Spheres are not consistent with regards to thread size, e.g. the cap from a Coke Sphere one year does not always fit on the cap from a bottle of a different year. Some Coke Spheres use double-start 12 TPI (Threads Per Inch) by 6 TPI (Turns Per Inch) threads approximately 27 mm outside size. Other Coke Spheres use 1.125 inch by 8 TPI (somewhere between UNC and UNF) threads. Thus a hydralist might want to own Coke Sphere taps for each year.

Alternatively, it is preferable to have a clamp-based adapter that simply grasps the bottle's lid ring, and accepts the pipe thread to mate thereto.

Coke Spheres sound good when fitted with piezoelectric pickups, one in each bottom region 10, each terminated in a ¼ inch phone plug. Typically the shield is not connected to anything at the bulb end, and only the tip and ring are connected. Typically there is a junction box with 12 or 16 or 21 jacks that connect in parallel, the output going to an electric guitar amplifier or other sound system. Preferably the sound system has a high input impedance balanced input, so that the effective series resistance in each pickup does not limit the bass response.

In manufacture of an electric hydraulophone, a “bender” piezoelectric element is connected to wires first, and then the “bender” and the connections thereto are placed in an upside-down Coke Sphere and the bottom region is filled with glue to seal the “bender” to the bottom region and also to protect the connections from water.

FIG. 1B illustrates an embodiment of the invention having oil-filled hydaulophone pipes with liquid fully sealed inside. Each pipe (for simplicity only one pipe is shown in this drawing) has a bulb or other (e)lastic medium at either end. This provides a complete sealing in of the fluid, so there is no chance of spill or leaking. In this way the user gives up the expressivity of touching the liquid, but it has the versatility that it can be used in places where a dry environment is required. For example this could take the form of a rank of Hydrapaison™ pipes in a church organ, where the instrument is played on the manual or pedal division by solenoid activated hammers, for example. The pipes might be situated in aquariums or water tanks within the church, so that the pipes are on display to the congregation. The double bulbing gives the advantage of a second transformer 15B. The second transformer can be used in reverse, or can be a pickup used in reverse. In this sense transformer 15 is a pickup (listening device) and transformer 15B is an actuator (transmitting device). Thus an amplifier 99 can be used to initiate feedback and sustain tones.

Alternatively, a keypress on the organ can simply turn on amplifier 99 and let feedback ensue without the need for hammer 30. Thus the acoustic vibrations in the water can be controlled electrically.

There are two top regions 11 and 11B, connected by a pipe nipple. When one bulb contracts it pushes liquid to the other bulb which expands, and vice-versa.

In this embodiment Coke Spheres do not work too well, because they don't uniformly expand or contract. Instead, a more uniform sphere that works more like a balloon works better. In particular, its primary mode of vibration must be one that increases or decreases total volume substantially.

FIG. 1C illustrates an embodiment of the invention having a soundingboard that functions as transformer 15. The soundingboard may be made of spruce, spalted spruce (spruce that has been treated with fungus), cedar, carbon fiber, fiberglass, or the like, or may contain metal resonators such as found in resonator guitars and the like. Vibrations in the elastic bulb are conveyed to the sounding board. The soundingboard may also form part of a hollow soundboard body 15S around or below the bulb. If the bulb is principally inside the hollow body 15S, there may be provided a body hole 19 for the bulb to be exposed for being struck by hammer 30 which may be keyboard activated, solenoid activated, or manually held, for example. There may be a plurality of holes 19, in body 19S, one for each bulb, or there may be a long slot or other opening in body 19S that exposes the bulbs to being struck by hammer or hammers 30.

The neck attached to the bulb may be partially filled, if desired, e.g. to level 43, so that the note can be tuned by filling or emptying the neck. The neck may also have a waterkeeper 41 held on by a removeable fastener 42 so that water is never lost until the user decides to open up the water supply to add or remove some. A satisfactory waterkeeper 41 is a thin rubber sheet. A satisfactory fastener 42 is a rubber band. Alternatively, an end cap can be placed on top of the pipe, so that waterkeeper 41 is a solid pipe cap. In this case there is no need for a rubber band or other fastener 42. The air above the water level 43 then provides the compliance or “give” that allows the water up to level 43 to vibrate up and down in the hydraulophone pipe.

The hollow body 15S may have a plurality of bulb body holes 19, one for each of a plurality of bulbs, mounted to the same soundingboard of transformer 15. Thus transformer 15 (the soundingboard) may be shared by a number of bulbs with various lengths of necks (or various amounts of water fill levels 43) attached thereto. Preferably the bulbs are the same size and the necks are of varying lengths, or the levels 43 to which the necks are filled are varied, in order to produce a musical scale.

FIG. 1D illustrates an embodiment of the invention having one or more hydraulophone pipes and their bulbs mounted above the soundboard that functions as transformer 15. Transformer 15 is a soundboard made from ⅛th inch cedar, framed with one-by-six cedar planks all the way around in frame 15F. The heavy frame holds the sheet of thin cedar securely all the way around its perimeter. The frame 15F and is made of cedar deck boards. The cedar transformer 15 and the frame 15F are stained or treated with Thomson's WaterSeal™ or the like. The transformer 15 may be cut from a ⅛th inch thick cedar plywood sheet, or other suitable material such as steam-bent wood for curvature (which improves the sound and makes an artistic form reminiscent of a cello).

Sound is conveyed to the soundboard transformer 15 by trusses 14T arranged in a tripod-like structure that conveys mechanical vibrations (“sound”, i.e. vibrations in solid matter at acoustic frequencies) from an upper sound plate 15T to the transformer 15. Trusses 14T are made of carbon fiber, but other suitable materials include wood, fiberglass, or the like. Trusses 14T are preferably rigid, stiff, and lightweight. When mallet 30 strikes bulb 14, the water therein Nessonates™ in the hydraulophone pipe formed by the pipe and bulb combination. Nessonance causes vibrations in the bulb which are transferred to sound plate 15T and thusly through trusses 14T into transformer 15, i.e. the soundboard, which is surrounded by frame 15F. The soundboard flexes at acoustic frequencies, causing air vibrations in the surrounding room, concert hall, playground, waterpark, or the like.

The setup of FIG. 1D puts all the bulbs above the transformer deck, so that they are more exposed to being easily struck by mallets, fingers, hands, or the like. This topside-design brings the bulbs outside the sound housing formed by transformer 15 and frame 15F. Such external-bulb configurations are easier to play, wherein the player does not need to reach under the soundboard to strike the bulbs.

FIG. 1E illustrates an embodiment of the invention having a pitch-bend pedal. The effect of the pitch bend pedal is to raise and lower the water level, e.g. the pedal can have a neutral position in which there is a medium water level 43M. Pressing down on the pedal with the toes sucks water out of the neck 16, causing it to drop to low water level 43L, sharpening (raising) the pitch of the note. Pressing on the pedal with the heel, pumps water into neck 16, causing the water level to rise to high water level 43H, lowering the pitch of the note.

The pedal has a pivot 43P, and ordinarily the heel rests above a reservoir 43R that is like an accordion reservoir. A satisfactory accordion reservoir is an Air-Evac™ container typically used to store photographic chemicals (ordinarily the Air-Evac container is squeezed down until there is no air in it, so as to preserve the photographic chemicals). An alternative reservoir 43R is a bladder, rubber squeeze bulb, or piston pump.

The pedal is connected by way of a clear plastic hose to a neck nipple 43N. The neck 16 is typically made of ¾ inch Schedule 40 stainless steel or clear plastic or PVC, typically ¾ inch Schedule 40. The nipple 43N is typically ⅜ inch diameter tubing having a wall thickness of approximately 1 millimeter.

When neck 16 is made of stainless steel pipe, the tubing of nipple 43N is welded to the pipe as follows:
1. the tubing of nipple 43N is clamped to neck 16;
2. the tubing is welded to neck 16 with a Dynasty 350 TIG (Tungsten Inert Gas) welder;
3. a hole is then drilled down the center of the tubing of nipple 43N into neck 16.
   The diameter of the hole is approximately 1/16th of an inch, which is small enough so as not to adversely affect the Nessonance of the liquid in the bulb and neck 16.

Now the liquid level can be made to rise and fall in the neck 16 while the player is tapping the bulb with hammer 30. The sound can now be made “droopy” and sad like a pedal steel guitar, or watery and fluid.

Moreover, since any desired note can be played, only one bulb and one neck is required, for playing an entire melody. The whole musical instrument can thus comprise only one bottle (Nessonator).

Alternatively, two can be used, one modulated with each foot, while one mallet is held in each hand. In this way the player can play harmony or accompaniment with one hand and melody with the other.

FIG. 1F illustrates an adapter 16A that adapts from an 8 threads-per-inch Coke Sphere as bulb 14, to a neck 16 that is a ¾ inch Schedule 40 pipe nipple having threaded ends 16NPT that are threaded with tapered National Pipe Threads having 14 threads per inch. Pipe nipples usually seal with tapered threads, but in this usage, I seal the ends against a washer 16W which is an “O-ring” having a rectangular cross section. The O-Ring mates against the one end of neck 16, the other end being finger hole 40. The instrument can be played either at finger hole 40, or by tapping bulb 14. The bulb has a very thin wall at the equator region 12, and a very thick wall at the bottom region 10. A satisfactory bulb is a spherical holiday-season Coca Cola “Coke Sphere”, but alternatively a custom bulb can be blow-molded. Preferably the bulb has wall thickness that varies from thick at the North and South poles, and thin at the equator.

The adapter 16A is tapped with a 1.25 inch by 8 TPI (Threads Per Inch) tap on the lower end that mates with the Coke Sphere, and is tapped with a 14 TPI tapered tap at the upper end that mates with the pipe nipple (neck 16).

The adapter serves 2 purposes:
adapts the bulb 14 to the neck 16, even though both have different threads.
secures the bulb to sound plate 15T to transfer sound thereto.

In this way, a pickup such as a piezo electric device on plate 15T can be used, or trusses can connect plate 15T to another soundboard.

Alternatively a soundboard can be used in place of plate 15T. In this way the bottles are screwed into adapters that wedge into a soundboard.

FIG. 1G illustrates an embodiment of the invention having a labium 40L and fipple mechanism 40F in place of the finger hole. Instead of touching or hitting the hydraulic fluid (liquid, e.g. water or oil, or the like), the player can play the instrument by pressing a key on a keyboard that causes water to flow from left-to-right through fipple 40F, across the mouth of the bottle formed by neck 16 and bulb 14. The water then flows across labium 40L. Labium 40L is a thin sheet of metal. A satisfactory labium is a piece cut off from a standard Venitian window blind slat, i.e. a thin piece of aluminum with a gentle curve to it. The curve is oriented to the metal sheet is concave downwards. It can be attached by hot melt glue to the end of the neck 16. Typically it covers about ¼ to ½ of the neck's end.

Preferably the entire instrument is immersed in liquid, such as water or oil. The liquid (hydraulic fluid) fills the neck 16, bulb 14, fipple 40F, and surrounding space.

In a church organ setting, a rank of hydrualophone pipes may be place in an aquarium or glass tank visible to the congregation. In this case the tank may be filled with oil and pipes played by pressing keys on the organ console. The rank of pipes may be selected by a drawknob labeled “Hydrapaisons™”. Top plate 15T may be mechanically connected to a soundingboard outside the tank, so that members of the congregation can hear the organ while sitting in the pews, rather than having to dunk their heads in the tank to listen to the pipes. However, a baptismal font may be fitted with Hydrapaisons™ so that special music can be played in a way that is only (or primarily) audible to those immersed therein.

In a rock concert the hydraulophone pipes may be placed in a clear acrylic hot tub together with the performer(s). Instead of using a keyboard to play the instrument, alternatively the labium and fipple can be hand held. In this way, a performer can have more expressive control over the sound.

Alternatively, the flow across the labium or labia can be initiated by blocking a water jet with the finger. In this way a row of water jets along the edge of a hot tub can be used to play a rank of Hydrapaison pipes.

In this embodiment, notes can sound for as long as the player wishes. As long a particular water jet is blocked, the corresponding note continues to sound and never dies out.

The hydraulophone pipes may be installed also in the wall space between the inner and outer walls of a hot tub, such as a SpaBerry™ hot tub.

FIG. 1H illustrates an embodiment of the invention having a basin 100B, a heater 100H, and a recirculating pump, 100P. This embodiment is suitable for being, or being installed in, a hot tub, or the like. Water from basin 100B is drawn into pump 100P where it passes through heater 100H to feed manifold 100M, which feeds one or more water supply lines 101S, 102S, . . . , etc.

The one or more water supply lines feed one or more user-interfaces 101U, 102U, etc., by way of one or more supply pipes 101P, 102P, . . . , etc.

The one or more supply pipes are typically rigid pipes, denoted by the thick vertical lines in the drawing, because one means to make a pipe rigid is to make it from relatively hard and thick-walled material, such as thick-walled Type 316 stainless steel, or the like. Plastic pipes may be used in some embodiments, if the pipes are thick enough, and especially if they are backed by some rigid material such as cement, concrete, or the like, especially in an inground pool or inground hot tub where concrete is typically used.

The water within the pipes 101P, 102P, . . . typically has a carefully selected mass that is linearly proportional to the length of the pipe. The speed of sound in water is about four and half times faster than in air, and the instrument of the invention often tends to produce lower notes, so in many embodiments of the invention we can neglect the time it takes sound to travel from one end of pipe 101P, 102P, . . . to the other, and consider the mass of water in the pipe as a single vibrating mass. In this case, we approximate the vibrations in the water as being uniform along the pipes 101P, 102P, . . . .

I shall refer to the product of the density (mass per unit volume) of the water and the length of the pipe, divided by its cross sectional area, as “capacity” or “capacitance”, and to this body of water itself as a “capacitor”.

I use the term “capacitor” as a variation on the force-current analog commonly used in control theory. For more reading on this analogy, see, for example, Control Systems, by Naresh K. Sinha, John Wiley & Sons, Hardcover, 488 pages, July 1995, ISBN-10: 0470235160, ISBN-13: 978-0470235164. The force-current analogy creates an analogy between mechanical systems and electrical systems in which capacitance is analogous to mass, inductance is analogous to inverse spring constant (i.e. a coil of wire is analogous to the coil of a spring with inductance in Henrys equivalent to inverse spring constant of the spring), and voltage is analogous to velocity, etc. Note that this analog theory differs from an earlier analog theory of James Clerk Maxwell in which voltage is analogous to force and current is analogous to velocity. Maxwell's version is called the force-voltage analogy. One advantage of the more recent force-current analogy is that voltage and velocity are both across variables (e.g. measured across two different points, such as when you stand on a moving train and watch another train go by, you're measuring relative velocity, as when you put a voltmeter probe from one point to another point), and that current and force are both through variables (i.e. force and current both occur at a single point).

We use a variant of the force-current theory in which capacitance is mass divided by distance to the fourth exponent, rather than letting capacitance stand for mass alone. This proves convenient in terms of factoring in the diameter of the user port (pipe 101P or 102P, or the like).

The capacitance of the pipes 101P, 102P, . . . is thus,

$$C = \frac{ρ l}{A} \qquad ( 3 )$$

where ρ is the density, typically in units of kg/m³.

Capacitance, C, of Equation 3 is in units of

$$\frac{\frac{kg}{{m}^{3}} m}{{m}^{2}} = kg \text{/} {m}^{4} . \qquad ( 4 )$$

When the finger holes or user-interfaces 101U, 102U, . . . are struck, touched, pounded or slapped, the capacitance of water in the rigid pipes 101P, 102P, . . . vibrates or oscillates due to the combined effect of the capacitance as described above, and an elasticity, lasticity, or elastic or lastic member, such as spring 101L, 102L, . . . .

In the FIG. 1C, the lastic members are depicted as springs. These can take the forms of flexible rubber hoses, one connected to each of the pipes 101P, 102P, . . . .

For example, supply lines 101S, 102S, . . . can each form one of the springs 101L, 102L, . . . if made of sufficiently suitable elastic, elastomeric, or lastic material.

In other embodiments springs 101L, 102L, . . . comprise bulbs of water. Each of the springs is implemented as a bulb of water, wherein the compressibility comes from the compressibilty of the water itself.

It is interesting to note that when I was inventing the hydraulophone, many experts in fluid mechanics discouraged me by telling me it was impossible to make an underwater musical instrument because water is not compressible. But despite the fact that people often refer to liquids as incompressible fluids, we should really say that liquids are less compressible fluids, when compared with gases. The fact remains that liquids are slightly compressible, i.e. there is some degree of compressibility, β=1/K which is nonzero.

In operation, the instrument of FIG. 1C presents the user with user-interfaces 101U, 102U, . . . numbering typically 12 interface holes on a diatonic scale covering a 1.5 octave range. In some typical embodiments there are 19, 33, or 45 user-interface holes, in keeping with the traditions defined by steady-state flow-based hydraulophones, although any number of holes from 1 and up, are possible with the invention.

In some embodiments, stemming from each hole is a meniscus 101M, and the instrument presents the user with a meniscusial user interface in which the user slaps the meniscus to create disturbances in the water.

Slapping the entire meniscus creates an explosive water-hammer sound, whereas hitting half or less of the miniscus creates a softer sound because it allows some water to escape while being struck.

It should be noted that the instrument responds to how hard and fast it is struck, as does a piano, but that there are further degrees of freedom as to how the meniscus is struck.

For example, you can hit the whole thing gently, or just a little bit of it very firmly. In both cases you can arrange it so the total sound level is identical in terms of how loud it sounds, but hitting it near the edge gives a more pure bell like quality whereas hitting it dead center and wholly gives it a more harsh and explosive kind of sound.

The sound in the instrument is produced by vibrating water. The vibrations in the water are very forceful but travel through small displacements. Thus to make them audible in a large concert hall, for example, it is preferable to have some kind of impedance transformation, such as by way of transformers 101T, 102T, . . . .

The transformers 101T, 102T, . . . may comprise pressure chambers similar to those found in an old Edison style phonograph, each supplying a horn. Thus the instrument might have 12 horns, each one made specifically for a specific note. As such the horns may each be optimized for the particular note they are made for, such that there is a large horn for the lowest note and a small horn for the highest note, and various sizes in between.

Alternatively, transformers 101T, 102T, . . . may be constructed with hydrophones (underwater listening devices) connected to an electric amplifier and loudspeaker. A satisfactory hydrophone is a Sensortech SQ34 hydrophone connected to an audio amplifier having a sufficiently high input impedance.

In some embodiments, it is preferable to feedback some of the electrically amplified signal to the springs 101L, 102L, . . . to increase the sustain of the instrument. A foot pedal may be supplied to dampen this feedback, and/or mechanically dampen the springs, much like the damping pedal of a vibraphone.

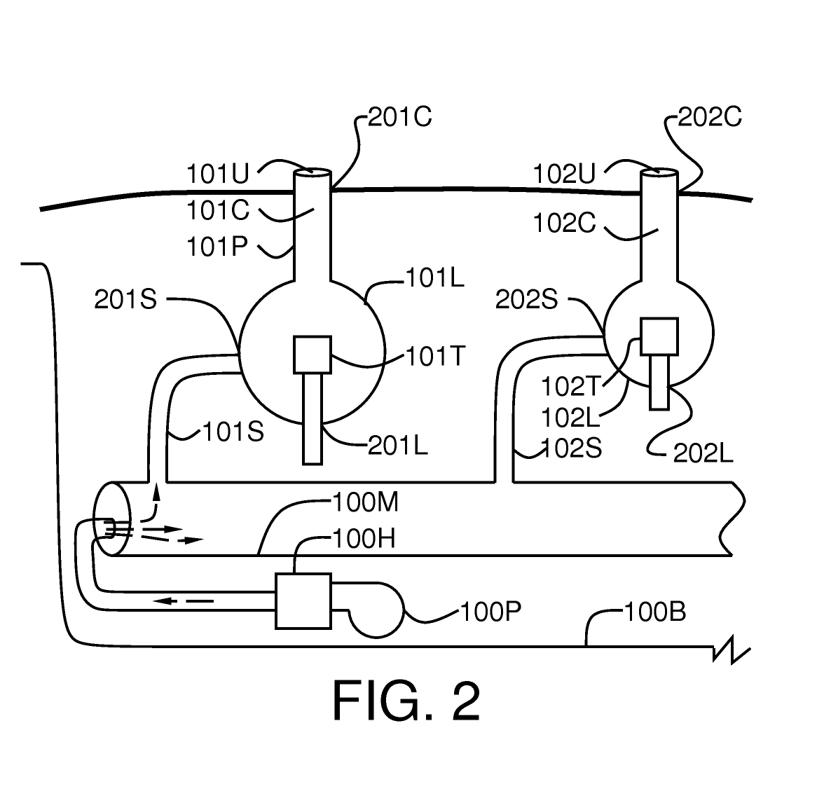

FIG. 2 illustrates an embodiment of the invention in which springs 101L, 102L, . . . are bulbs of water. The water itself forms the spring. Although liquids are often said to be incompressible fluids (researchers often refer to gases as compressible fluids and liquids as incompressible fluids) there is some nonzero degree of compressibility that liquids possess, even though the degree of compressibility is very small.

Let the degree of compressibility of the fluid, such as water, be denoted by

$$β = - \frac{1}{V} d V / d p .$$

We prefer to use the incompressibility which is the reciprocal of the compressibility: K is the incompressibility given by K=−Vdp/dV, which is more like the familiar “spring constant”.

The elastic medium of FIG. 2 is specifically a bulb of liquid, and if the walls of the bulb are inelastic, let us denote the elasticity, lasticity, by the letter “L”, as in eLastic, or buLb:

L=V/K=Vβ (5)

Let us define this value, L as being analogous to inductance. It has units of:

$$\frac{{m}^{3}}{\frac{kg}{m {s}^{2}}} = \frac{{m}^{4} {s}^{2}}{kg} . \qquad ( 6 )$$

The resonant frequency of each note is given by:

$$f = \frac{1}{2 π \sqrt{L C}} . \qquad ( 7 )$$

In the case of an inelastic bulb, this is approximately:

$$f = \frac{c}{2 π} \sqrt{\frac{A}{V l}} , \qquad ( 8 )$$

where c is the speed of sound in the water,

$$c = \sqrt{\frac{K}{ρ}} ,$$

A is the area of the user-interface or neck, l is the length of the neck, and V is the volume of the bulb.

This inelasticity can be approximated by encasing the bulbs in concrete to make sure they don't offer much, if any, springiness in and of themselves. In one embodiment I encased variously modified (i.e. variously sized for various notes) Bordeaux wine bottles in concrete, to make a set of hydraulic resonators which I referred to as Nessonators™. The word Nessonator is a word I made up from the words “Nessie” (as in the giant sea snake said to inhabit Scotland's Loch Ness) and “resonance”. The name “Nessie” is a trademark that I have been using for my aquatic musical instrument inventions, and I have sold these under the name “Nessie™”

A Nessonator (hydraulic resonator) can be made from a rigid pipe connected to a rubber hose, or from a rigid pipe connected to an elastic bulb, or from a rigid pipe connected to a rigid bulb, or from a rigid pipe connected to a diaphragm, or from a wide variety of other means.

When the Nessonator is rigid, such as can be approximated from a concrete bottle, we get a philosophical purity in the instrument, in the sense that the sound comes primarily (or wholly) from vibrating water, that has very little (or no) influence from the materials from which the instrument is made.

I call such an embodiment a waterflute, to distinguish it from an instrument that makes sound from vibrating water in conjunction with vibrating solid matter.

Embodiments of my invention that use a combination of vibrating water and vibrating solid matter might aptly be called “hydraulidiophones”, a portmanteau of “hydraulophone” and “idiophone”. In selling such instruments I use the tradenames “CLARINessie™” (analogous to a clarinet which makes sound from vibrating air in conjunction with vibrating solid matter of a reed), and “H2Oboe™” (hydraulophones that have more than one reed associated with each finger hole).

A 12-jet CLARINessie™ thus has 12 reeds, whereas a 12-jet H2Oboe™ typically has 24 or 36 reeds (2 or 3 per finger hole).

When the bulbs for springs 101L, 102L, . . . are made of material that is not rigid, the instrument behaves partly as a waterflute, but also exhibits features similar to that of the CLARINessie. Embodiments of the invention can also be made from pipes themselves that are somewhat elastic, or from joining elastic to inelastic pipes, or the like.

Whether the bulb is rigid, elastic, or whether there is no bulb at all (i.e. where the springs are elastic disks, cylindrical slugs, rubber hoses, or otherwise, we may continue to use Equation 5 but with a modified value of L analogous to the “equivalent inductance” that defines the resonant frequency

$$f = \frac{1}{2 π \sqrt{L C}} .$$

Referring once again to FIG. 2, pump 100P pumps water (possibly through heater 100H if present) to a bottle supply manifold 100M, from which supply lines 101S, 102S, . . . keep the bottles of the underwater bottle organ topped up. Springs 101L, 102L, . . . are the bulbs (bodies) of the bottles, and pipes 101P, 102P, . . . form the necks of the bottles.

If the bottles are encased in concrete, or simply are concrete, then they can be suspended by any part of the bottle, typically. However, if the bulbs are elastic, then they should be suspended as may be achieved by grasping the bottles by their necks, with bottle clamps 201C, 202C, . . . .

Clamps 201C, 202C, . . . may be retort clamps, or they may be simply a means for holding the bottles, such as by welding the bottle necks to a metal plate when the necks are made of metal.

Each bottle has a transformer 101T, or 102T, or . . . , positioned near the center of its bulb.

A non-damping bottle holder as described above, or as facilitated by other means, is kind of like the way a glockenspiel or metallophone has the metal bars or pipes held at the nodal points. If the bottle is in fact idiophonic, then a non-damping bottle holder should grasp it in such a way as to be grasping it at or near its idiophonic nodal points.

When the bottle is encased in concrete, just about any mounting will be a non-damping bottle holder.

Preferably the bottles each have a bottle fill port or supply port 201S, 202S, . . . and a listening port 201L, 202L, . . . .

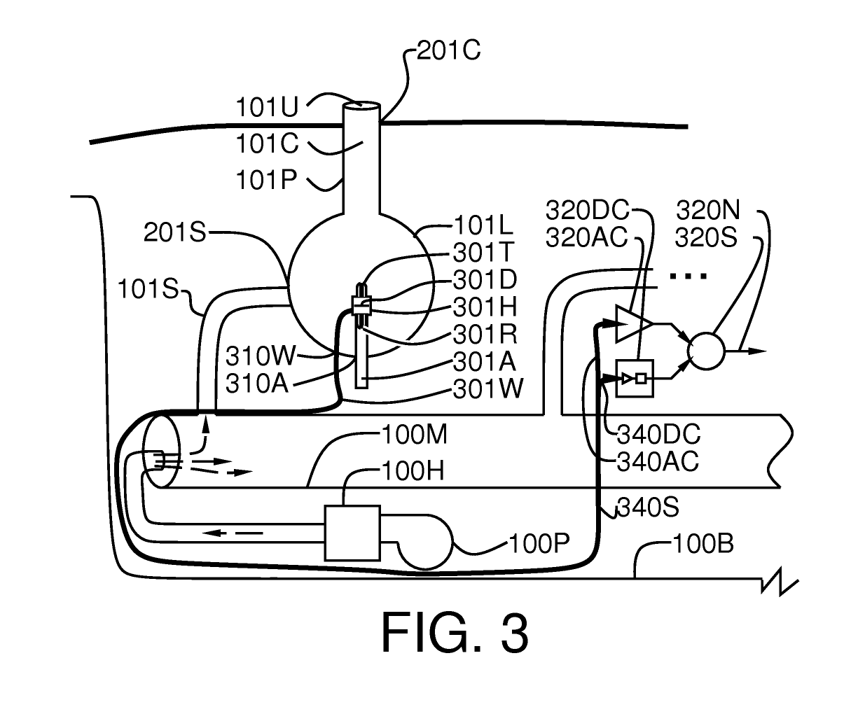

FIG. 3 shows an AC+DC (Alternating Current+Direct Current) embodiment of the invention in which an eLastic buLb such as spring 101L is fitted with a differential diaphragm sensor hydrophone 301H. The hydrophone 301H is a differential pressure sensor having two ports, an acoustic transformer port 301T and an atmospheric reference port 301R. Alternatively a flow sensor, pressure switch, or flow switch may be used, or a combination of devices, such as a hydrophone to listen, and a flow switch or pressure switch to respond to changes in flow or pressure.

Consider, for the moment, a single diaphragm sensor for hydrophone 301H, such as a piezoresistive pressure sensor having a thin glass diaphragm 301D fitted with piezoresistive strain gauges arranged in a wheatstone bridge. The bridge is supplied by a 12 volt center-tapped power supply with a grounded center tap, i.e. to supply the bridge with ±6 volts. There are four conductors in cable set or wire 301W. Wire 301W being a 4-conductor wire or cable assembly has two input conductors from the plus minus 6 volts, and two output conductors that connect to a high gain analog instrumentation amplifier 320AC. Amplifier 320AC may be capacitively coupled, if desired, so that a very high gain can be achieved without problems with DC offset. It may comprise many stages of amplification, AC coupled (i.e. capacitively coupled).

The AC signal processing track responds to transient sounds that make the instrument a bottle piano, i.e. to capture the percussive effects of water hammer. A parallel processing path also makes the instrument simultaneously function as a bottle organ. Processor and amplifier 320DC capture show changes in pressure inside the bottle. The processor part of processor and amplifier 320DC frequency-shifts the DC part of the input signal 340S from hydrophone 301H. This can be done by a convolution in the time-domain, or by a shifting in the frequency domain (i.e. Fourier Transform, followed by shifting samples, followed by inverse Fourier Transform), or the like. Alternatively, the processor part of processor and amplifier 320DC can be a voltage-controlled oscillator tuned to the same frequency as the resonant frequency of the bottle. In this way, when you press your hand on the mouth of the bottle, and hold while pressing down, the pressure in the bottle stays high as long as you hold down, and thus a tone sounds for as long as you press down on the mouth of the bottle.

Thus the instrument behaves like a piano and an organ at the same time. Slapping the mouth of the bottle with the palm of the hand makes a percussive sound from resonance in the bottle. Pressing and holding makes a steady drawn out sound.

A High Dynanic Range (HDR) signal processor 320S combines the AC (“piano-like”) and DC (“organ-like”) signals 340AC and 340DC. If one of the signals clips, for example, it can be moderated down in its effect, as compared to the better (i.e. nonclipping) of the two signals.

Any number of separate signal processing pathways can be used. For example, there can be a high gain AC path, a low gain AC path, a high gain DC path, and a low gain DC path, all four of which can be combined to give a high dynamic range signal, using HDR processing with certaintly functions as described in the IEEE Transactions on Image Processing, in an article entitled “Comparametric Equations”, in volume 9, number 8, ISSN 1057-7149, August 2000, pages 1389-1406.

In some embodiments amplifiers 320AC and 320DC are potted in resin and placed inside the bulb together with hydrophone 301H, for 2 reasons: so that they are (1) close to the source, and (2) so that they are at the same temperature is hydrophone 301H. In fact a thermistor inside the amplifier assembly can be coupled to hydrophone 301H for temperature compensation against drift, especially useful in amplifier 320DC where offset drift might otherwise push the output 320N into the supply rails or saturation or cutoff.

An atmospheric reference pipe 301A emerges from the bulb spring 101L of the bottle. Wiring 301W also emerges from the bottle.

Each bottle has 4 ports:
a wiring port 310W;
an atmospheric reference port 310A;
a port for supply lines 101S, 201S, . . . ; and
a port for the user-interfaces 101U, 102U, . . . .

When I refer to “listening device” I refer to a device that may sense quantities outside the range of human hearing. Much of the DC part of the signal captured by hydrophone 301H is subsonic. In some embodiments, instead of using one sensing or listening device to sense the AC and DC, we may use separate devices. For example, amplifier 320AC may be supplied with an AC hydrophone such as a Sensortech SQ34, that is not a diaphragm sensor. Processor and amplifier 320DC may be supplied with a separate pressure sensor, pressure switch, flow sensor, or flow switch that senses when a finger or hand has blocked the mouth of the bottle, and sounds, triggers, or shifts a steady note out signal output 320N for as long as the mouth of the bottle's mouth remains blocked.

We may regard the DC capabilities of the machine as an ORGAN-izer, which takes the bottle piano and makes it work like an organ, because you can slap the top of the bottle's mouth with the palm of your hand and make a very ORGAN-like sound, like a pipe organ, that keeps on sounding for as long as you would like.

In fact you could press a cork into the bottle's mouth, and walk away, and leave it for a day or two and it would still be singing when you came back, and it would keep singing until you pulled the cork out again.

Another embodiment, rather than separate AC and DC paths, is to have a reverberation unit, such as a guitar effects pedal or other revereration unit whether it be based on something like the SAD1024 bucket brigade Charge Coupled Device type echo unit, or more like a digital delay or analog delay or tape loop or the like, just about any suitable revereration or echo unit. The reverberation unit is connected to the pressure sensor, so when the pressure increases, it captures and loops whatever sound the bottle last made or recently made.

So if you slap the bottle with your palm, it makes the sweet sound of the bottle piano, and the sound is captured in a loop that gets held for as long as there is pressure in the bottle.

The sound is bottled up in the bottle for as long as you like, and keeps echoing or reverberating until you let go, and let it escape from the bottle.

In a computerized embodiment (e.g. using a processor for the reverb, where the same processor “listens” (is responsive) to the bottle through AC and DC signals of one hydrophone, or to separate AC and DC hydrophones), this is done, using, for example, a delay loop or echo loop, which might itself be realized, for example, using a buffer, to process and transmit the sound to a sound production system such as a speaker and amplifier system, as follows:
1. initialize loop buffer to zero;
2. begin acquiring data from the AC channel and DC channel;
3. when DC is not present, transmit the AC signal to the destination sound production system unaltered but also record or capture the sound into the loop buffer as well as transmitting it;
4. when DC is present, transmit the sound from the loop buffer instead of live from the AC channel;
5. continue acquiring the DC signal;
6. continue looping the recorded AC signal and playing it back, i.e. transmitting it, repeatedly to the sound production system, for as long as the DC signal is present;
7. when the DC signal becomes absent:
   (a) stop looping the AC signal (i.e. stop playing it back and transmitting it) to the sound production system; and
   (b) restart transmission of live AC signal to the sound production system.

In some embodiments of this aspect of the invention, it is desirable to have a more fluidly continuous rather than abrupt transition between AC and DC modes. Thus what I like is to be able to tap a bottle mouth and then also press down a little while tapping, and have a nice blend of AC and DC. In some embodiments this is achieved as follows:
1. initialize loop buffer to zero;
2. begin acquiring data from the AC channel and DC channel;
3. when DC is less present, transmit more of the AC signal to the destination sound production system unaltered but also record or capture the sound into the loop buffer as well as transmitting it;
4. when DC is more present, transmit a greater proportion of the sound from the loop buffer, and a lesser proportion live from the AC channel;
5. continue acquiring the DC signal;
6. continue looping the recorded AC signal and playing it back, i.e. transmitting it, repeatedly to the sound production system, in proportion to the strength of the DC component of the signal.
   Additionally, the nature of the AC sound loop can be varied in proportion to the DC signal.

Alternatively, the DC input can be frequency-shifted using the AC input as a shifting signal. When I speak of DC input here, what I really mean is the subsonic sounds made by the water, including the static pressure (zero frequency) and surrounding low frequencies. These are not a pure Dirac Delta measure at the origin (f=0), but, rather, spread about the origin with much energy at the origin plus some energy around the origin. This whole DC signal is then shifted up to match the AC signal that is centered around the resonant frequency of the bottle, 1/(2πsqrt(LC)). Then the two can be added together or combined in other ways, such as, for example, using the DC signal to control aspects of the AC signal beyond merely the reveration described in the algorithm above.

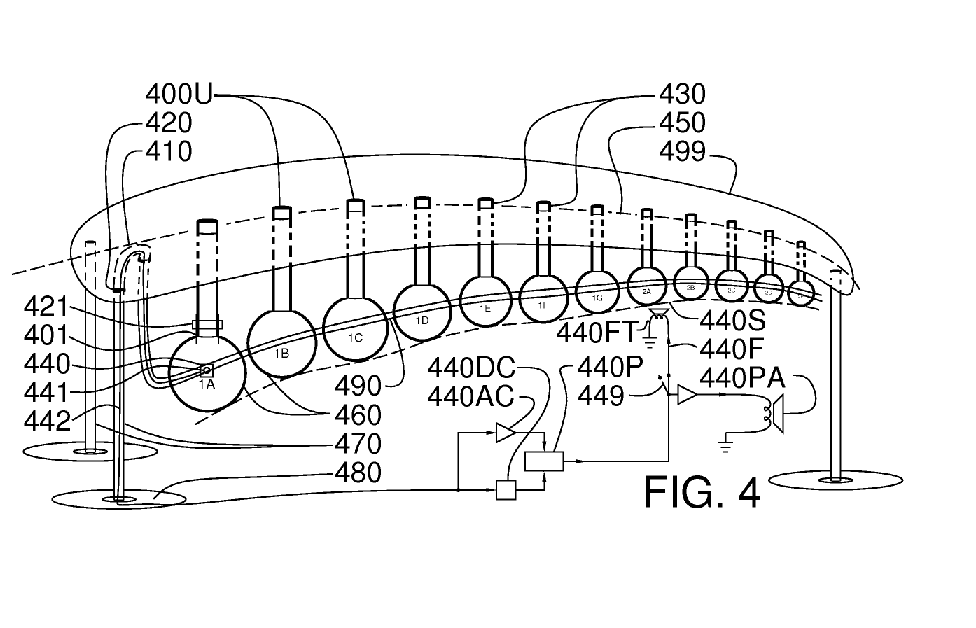

FIG. 4 illustrates a bottle-based embodiment of the waterhammer piano invention. Twelve bottles 460 are held by their necks using bottle clamps 430 that suspend the bottle tops through a basin 499 where they can be struck by the player. Typically the instrument is played by striking the meniscus of the water brimming from the mouths 400U. Alternatively, the index finger can be tapped downward onto the edge of one or more mouths 400U.

The mouths extend into the basin past a centerline 450. The centerline is the line through the centers of each neck, at the point where it intersects the basin, i.e. the line that defines the boundary between the user-interface portion of the bottle necks, featured as protruding mouths 400U, and the part of the bottle that hangs down below the basin.

The apparatus looks like a vibraphone in some regards, in the way that the pipes hang down below an area the user interacts with. The basin 499 is generally curved on a 3 to 5 foot radius (approximately 1 to 2 metres radius), and the user (i.e. the player) stands or sits in a position that is approximately equidistant to all of the mouths 400U.

Mouths 400U are user-interface ports that the player can interact with individually or with more than one mouth simultaneously. A utility line 490 provides concealment for water supply and electrical connections. There may be separate electrical conduit and water supply or these may be integrated. For example, a water supply may run in front of each bottle and an electrical conduit may run behind. These may be styled similarly so that the general appearance is that of a band circling around the bottles, either collectively, or individually, as an aesthetic that represents rings around, or an orbit around a planetary celestical body, or the like.

Typically line 490 is in the shape of a gentle swoosh that provides some physical support to the bottles, and also protects them to some degree, as well as providing water supply and electrical connectivity.

Inside each bottle 460 is a listening device, or listening devices. In one embodiment there is a Sensortech SQ34 hydrophone in each bottle, as well as a 26PCF type pressure sensor and signal conditioner. In another embodiment the pressure sensor is a broadband pressure sensor that listens in both DC (i.e. low frequencies that include the frequency origin f=0) and AC (i.e. high frequencies further from the origin).

The basin is supported on legs 470. Typically the basin and overall design of the instrument is suggestive of the “Nessie” style hydraulophone, itself inspired, in shape, by the snakelike creature said to inhabit Scotland's Loch Ness.

The instrument generally has a bulbous “head” end where the lower notes (larger bottles) are located, and a more slender “tail” end where the high notes (smaller bottles) are located. The head is supported by two leg pipes, and the tail by only one leg pipe. This gives a total of 3 points of support. The instrument, standing on 3 legs, is very stable even if it is not anchored to the ground.

In a typical playground or waterpark installation, the supports are anchored in the ground and covered by a security plate 480 which also serves as a toe guard to make a nice smooth surface with the ground.

Water supply comes in through one of the supports. Another serves as the electrical connectivity, and a third support acts as the water drain from the basin, so that a user in a wheelchair can be parked under the instrument and not get too wet from dripping water.

In some embodiments, the water can also just overflow from the basin 499 in a way that is designed so that it runs off to the sides, and does not drip onto a user seated under the basin.

The water supply comes from underground, up one of the three legs 470. On that leg is a length of flexible hose 410 secured by pipe clamps 420 to the leg and to the water input of the utility line 490.

Hydraulophones generally keep very good tune, but in exceptionally critical applications, some embodiments can be user-tuned, by way of a tuning stub 401. Stub 401 consists of a channel insert into each bulb that allows the bulb to slide up and down on the neck to fine-tune the length of the neck and thus the Capacity, C of water in the neck. A tuning clamp 421 locks the tuning into place.

An added advantage of this arrangement is that it facilitates easy cleaning of the bulbs should there be vandalism in the form of insertion of garbage into the mouths, when the instrument is installed in a public place. Clamps 421 are operable with a special security keyscrew mechanism, so that key holders can tune the instrument and clean the bulbs. Keyholders can be trusted members of the society, when the instrument is installed as a civic sculpture or architectural centerpiece. In waterparks, the keyholders can be the lifeguards or maintenance staff. In residential units, in the consumer market, a responsible family member may assume the role of tuning or cleaning the instrument.

A listening device in each bulb, such as hydrophone 440 in the largest bulb, shown (hydrophones in each of the other bulbs are present but not shown in the drawing, in order to keep the drawing simple and free of clutter) has a vent 441, which is a reference to atmosphere. The vent can be double split so that it can serve as or contain the reference to atmosphere for the hydrophone as well as the water supply to the bulb. In this embodiment the hydrophone is a type 26PCF diaphragm sensor having a programmable DC-coupled amplifier and temperature compensation onboard with an Atmel AVR onboard with it to control it and monitor the temperature. The AVR is thermally bonded to the diaphragm sensor to sense its temperature and compensate for offset drift that otherwise plagues high-gain DC systems. The gain is high enough to hear small-signal sounds made in the bottle as well as sense the DC pressure and subsonic pressure waves in the bulb.

A connection 442 comes from each of the hydrophones and runs through the line 490 and down one of the legs 470, underground, through an underground conduit to a dry electrical vault where there are housed 12 AC/DC processors, one for each hydrophone. Each processor 440P receives input from an AC channel 440AC and a DC channel 440DC. The processed result is fed to a sound playback system such as a speaker system to make the instrument loud in a waterpark where there are a lot of screaming children and spraying water which makes it hard to hear the natural acoustic sound of the instrument. The electric amplification of the instrument is suitable for use in large rock concerts or large public demonstrations, or to provide a nice background sound in a waterpark where a particular child can enjoy the feeling of performing for the whole park while hitting water and having fun and frolic. A sound system such as a Public Address system 440PA reproduces the sound from each of the 12 bottles throughout the waterpark, and a portion of this signal may also be used as a feedback signal 440F fed back to the instrument on soundboard 440S. The soundingboard may be present along the bottoms of the bottles, or along any part of the bottles that resonates. The purpose of the sounding board feedback signal 440F is to sustain the sound, much like the way an electric guitar feedback system works in a guitar such as the Moog guitar. The feedback signal goes to a feedback transducer 440FT. A satisfactory feedback transducer is a geophone such as a Clark Synthesis Part Number AW339 tactuator.

Alternatively, flat bottom bottles may be placed on a special sounding surface. A satisfactory sound board is a plastic folding table. Bottles placed on such a table have an almost magical property when there is a speaker under the table that plays back the sound from a hydrophone in the bottle, while striking the meniscus of the water. The sound feeds back into the vibrations in the bottle, causing the sound to have an almost bell-like clarity and sustain. It sounds much like a Fender Rhodes piano (i.e. the kind of piano made from an array of tuning forks). To build an embodiment of this aspect of the invention, you can take one or more flat bottom bottles such as Erlenmeyer flasks, and place them on a plastic folding table which is basically a thin membrane of plastic. It works best when the plastic is wet, so the bottle bottom makes an acoustic bond to the table. Alternatively, a sheet of glass can be welded to the bottom of a bottle, or an aluminum bottle can be welded to a sheet of aluminum or the like. A speaker placed under the table (or better, a tactuator such as a Clark Synthesis Part Number AW339 can be connected directly to the table). The output of an amplifier supplies sound to the tactuator or speaker, and the input of the amplifier is connected to a hydrophone in the bottle and the bottle is filled all the way with water, so it brims over a little bit. When you strike the meniscus of water, if the gain is just right on the amplifier, you get what sounds like a tuning fork, of such pure tone, that the sound is very remarkably beautiful and pure, even though the bottle itself is far from idea. In this aspect of the invention, a relatively low quality (low “Q”) bottle can be used but the result is a very high Q peak. For example, you can put an array of Coke™ bottles on the plastic table and tune everything up right and get something that sounds like a very beautiful set of tubular bells. Then you can play “We'd Like To Teach The World To Sing” (the Coke song) on the bottles and it sounds like tubular bells or chimes. Alternatively you can fill up some Budweiser™ beer bottles with water, and play a Budweiser jingle on the bottle piano.

In the instrument shown in FIG. 4, such sweetness of tone that results from this feedback may be controlled by a sustain pedal switch, 449. Stepping down on pedal 449 closes the circuit to the feedback signal 440F to give that spiritual celestial bell-like sound. Letting up on the pedal gives a more quickly decaying sound. In the drawing of FIG. 4, the switch is shown in the closed (down) position, i.e. with the sustain on for the nice bell-like sound, in a solid line. In a dotted line the switch position of the switch being open (pedal up) is shown.

With this pedal control, the waterhammer piano behaves more similarly to a regular piano with the use of the pedal. Alternatively, a pedal with a potentiometer can be used. For example, a standard 14-pin connector can be put on the instrument, and a standard Miller Elecric TIG welding control pedal, Miller Part Number 194744, can be used, with the wiper pin to the feedback signal 440F, the top of the potentiometer to the output of processor 440P, and the bottom of the potentiometer to ground. Thus stepping down more on the pedal increases the feedback, and easing off a little bit reduces the feedback a little bit. Alternatively a wireless control can be used.

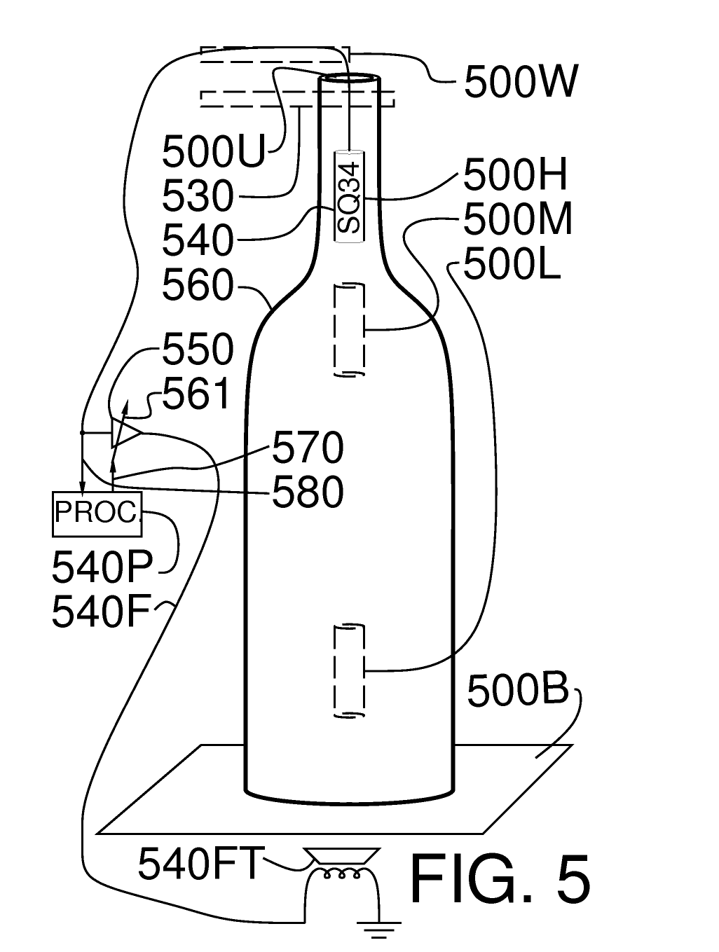

FIG. 5 illustrates a tuning embodiment included in the invention. This embodiment comprises one or more bottles filled with water. Depicted in the FIG. 5 is a Bordeaux wine bottle with a flat bottom. For feedback purposes an Erlenmeyer-shaped wine bottle works even better, but the bottle shape shown in FIG. 5 comprises a working embodiment of a tuning system, as well as a satisfactory feedback system.

Tuning can be achieved by filling the bottle to varying degrees, to affect the effective neck length. The water should extend into the neck to some degree in order to get the bottle to Nessonate (i.e. to exhibit hydraulic resonance as a water-based Helmholtz resonator). As the bottle is filled more, the Nessonant frequency decreases. It can be tuned by filling to the correct height, and then the neck can be cut off at that height to get a minuscus-based user-interface.

However, it is preferable to be able to fine tune the bottles without having to partially fill them, or cut the necks (or weld on more tubing to lengthen the necks) each time.

A sliding neck with telescoping tubing, one sliding into the other, is also possible. But a better approach is to simply use an insert into the neck that occupies some space inside the neck. This will narrow the neck and lower the pitch. Inserting it further (or inserting a bigger “space taker-upper”) lowers the pitch further.

The space occupier in the neck reduces the sharpness of the Nessonance, so alternatively, the hydrophone itself may be used as the tuning mechanism. The reason this makes sense is that the hydrophone has to be in there anyway, so we might as well use it to tune the bottle.

The setup in FIG. 5 shows the hydrophone up in the neck, in a high position 500H. A mid position 500M is shown in dotted lines. A low position 500L is also shown in dotted lines. As the hydrophone is lowered down, the pitch rises because the neck becomes free of the choke-point and widens out. As the hydrophone goes down the pitch goes up, to a point, and then lowering the hydrophone further causes the pitch to fall back down again.

There is some point of maximum pitch, where the hydrophone is between the highest and lowest points.

Tuning the bottle by raising and lowering the hydrophone is done by having it hang by its wiring, with wire holder 500W that grabs the wire and lowers or raises the hydrophone in the bottle.

A satisfactory hydrophone 540 is a Sensortech SQ34, which has a relatively high Effective Series Capacitance (ESC) of 15 nF (nano Farads), and a good sensitivity of approximately −200 dB (more exact figures for Serial Number 0367 of a set of 36 Sensortech SQ34s was 15.22 nF and −200.14 dB). The wiring 580 from the hydrophone 540 is connected to a voltage and phase controlled preamplifier as well as a processor that controls the voltage and phase of the preamplifier by way of control signal 570.

The hydrophone is connected to half of a Hosa Technology 25 foot (approx. 8 metres) gay male (i.e. male to male) balanced patch cord (i.e. TRS male on one and TRS male on the other end), which, when cut in half, yields two 12.5 foot (approx. 4 metres) cables, having a shield, and a red and white wire. The cut end is stripped back about 12 inches (approx. 30 cm) outer rubber, and back about 6 inches (approx. 15 cm) inner rubber, exposing the white wire (ring) and red (tip) conductors. The shield is cut off, and glue-shrinked (glue-shrink tubing, i.e. marine grade shrink tubing impregnated with adhesive). The white wire goes to the black hydrophone wire and the red goes to red, using smaller glue shrink (adhesive shrink tubing).

This connection results in a balanced quarter inch (approx. 6 mm) plug that plugs into standard TRS (Tip Ring Sleeve) balanced quarter inch audio equipment. The ground of the amplifier 550 is connected to the shield of the hydrophone cable at the plug end only (the other end is not connected) and this ground is connected to any nearby railings or other metal parts, if they are not already bonded to the circuit ground of the apparatus. Additionally the liquid in the bottle may be grounded, if necessary, by way of an inserted grounding connection into the bottle. All materials in the bottle should be of high “Q” (i.e. low dampiness) so as not to dampen the vibrations in the water.

Audio equipment is used to amplify the hydrophone sound and feed some of that sound back to the base 500B upon which the bottle(s) sit(s). Satisfactory audio equipment comprises a Peavy model 16FX mixer which has 12 microphone inputs that can be used for 12 hydrophones, one in each bottle, for a 12-bottle piano.

The output of the Peavey 16FX is connected to the input of an amplifier such as an AudioPro 3000 (3 kW output power), split into a subwoofer such as a Yorkville Audio Elite SW800, and a mid cabinet such as an Elite EX401. The Peavey 16FX together with the AP3000 and associated electronic crossover, and an additional computer-controlled preamplifier comprise amplifier 550 which amplifies the hydrophone signal to a speaker or speakers that comprise feedback transducer 540FT. The use of a computer-controlled preamplifier allows the phase and gain of the amplifier to be dynamically adjusted to cancel or enhance feedback, in order to control the sustain and to get a nice bell-like quality from a cheap and readily available Bordeaux wine bottle. This avoids the need for more expensive Florence flasks, and also allows easier modification of a set of bottles into different sizes by using a bottle cutter to cut parts out of the bottle and change its size in order to make a set of 12 welded bottles in a musical scale.

The setup shown here in FIG. 5 is suitable for doing a large rock concert, with a 12 bottle piano, but for a smaller demonstration of the invention, a small backpack-based battery operated speaker-amplifier can also be used to excite the base 500B upon which the bottle sits. A satisfactory base for base 500B is a Realspace™ folding table, with molded plastic top, model 29 H×72 W×30 D, 774491 from Office Depot, or a “Lifetime 4 ft. Adjustable Height Folding Table”, model 48×24, with a table top constructed of high-density polyethylene (HDPE) plastic. The base 500B is thus the thin membrane of HDPE plastic. This behaves like the sounding board of a piano or violin, and conducts the sound from the bottle to the surroundings, as well as from the surroundings to the bottle. The table sits upon table legs that rest upon rubber safety tiles, such as 4 inch (approx. 100 mm thick) SofSurface tiles. Each tile has 64 springs in it to absorb shock and isolate the surface 500B from the ground, so that the instrument does not pickup too much vibration from footsteps or passing vehicular traffic, railway cars, streetcars, or the like.

Alternatively, a bottle clamp 530 suspends the bottle, and a sounding plate is used in place of base 500B. The sounding plate is a glass membrane welded to the bottom of the bottle, or it can be a piece of rigid carbon fiber, kevlar, plastic, or thin fiberglass bonded to the bottom of bottle 560. The sounding plate or sounding board board helps project the sound into the surrounding air, as well as helps to receive sound feedback from amplifier 561 by way of feedback from the ambient sound without the need even for explicit feedback transducer 500FT. In fact feedback transducer 500FT can simply be the main PA system in the concert hall or venue, and it doesn't need to specifically be under the table or base 500B pointing up, if it is sufficiently strong.

A processor 540P listens to the hydrophone and rides the volume gain of amplifier 550 up and down, to produce feedback signal 540F of such strength as to sustain feedback, that is filtered through the resonance of the water with the bottle. Optionally, a phase adjustment is also dynamically made to track and maintain feedback.

A very light tap on the meniscus at the top of the bottle, or just a downward tap with the index finger on the rim of the mouth 500U, will set the resonance in motion, and begin a tone that can be sustained for as long as desired by way of the feedback.

A pedal connected to processor 540P controls this feedback process so it can range from heavily damped to infinite sustain. A satisfactory pedal is the Miller Electric Part Number 194744, or any other pedal comprising essentially a potentiometer and or switch (or both, as is the case in the Miller pedal).

The feedback processor uses a simple algorithm to keep the feedback going, if and when this feedback is desired. The algorithm proceeds as follows: check pedal; if sustain is desired, proceed as follows:
if pedal is depressed fully, initiate infinite sustain as follows:
   increase gain until hydrophone clipping results or is about to result (this occurs when the hydrophone signal from the vibrating water exceeds the range of linear input of the amplifier);
   decrease gain by a small increment to and monitor voltage drop;
   repeat adjustments in gain to maintain a steady-state tone for as long as the pedal is depressed fully;
   if pedal eases off, decrease gain to allow any sounds to die out exponentially; let gain remain proportional to pedal position;
   if pedal eases off completely decrease gain completely (in the case of the 5-wire 14 pin Miller pedal, the switch is used for this purpose, e.g. to shutdown the sound when the pedal backs off completely).

Not all embodiments of the invention require feedback. For example, a very nice embodiment of the invention can simply be made from a dozen or so bottles, fed into an amplifier.

In some embodiments the bottles can also be identical, e.g. made from two six-packs of Coke bottles, and instead of having each bottle be made a different size, they are pitch-shifted to notes on the scale. Suppose for example, we have a dozen identical bottles that all produce a middle “C” when struck at the top. We simply need to have 12 hydrophones, one in each bottle, and frequency shift the first “C” down to an “A”, the next “C” down to a “B”, leave the third “C” as is, shift the fourth “C” up to a “D” and so on. In this way we get the natural minor scale that is typical of hydraulophones, i.e. A, B, C, D, E, F, G, H (high A), I, K, K, and L (high E).

A collection of frequency shifters arranged in this way is called a shifterbank. Thus the invention described here can be implemented using a number of bottles connected to a shifterbank.

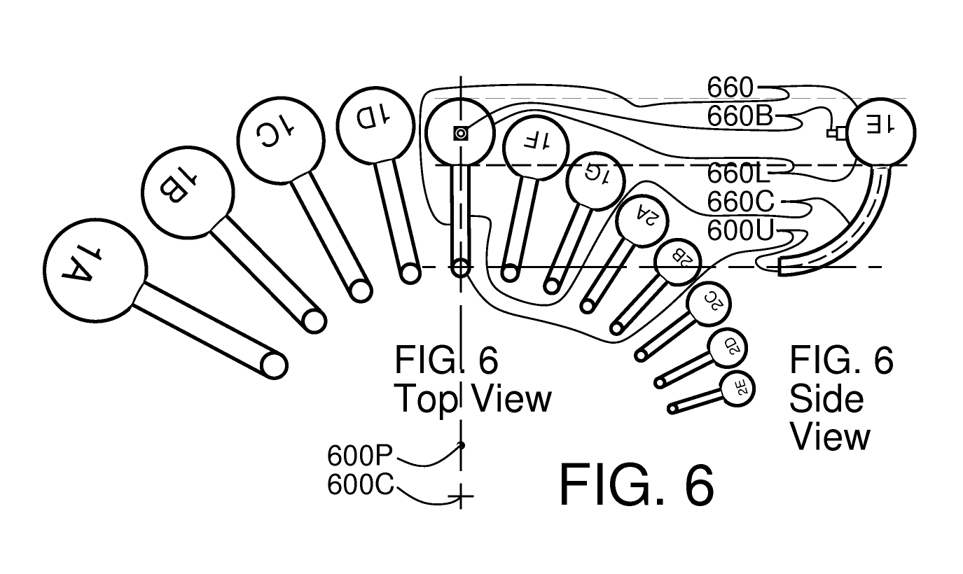

FIG. 6 illustrates a close-fingering embodiment of the bottle piano organ, in which the necks 660C are curved or bent so that the bulbs 660L of the bottles 660 swing up and away, thus allowing the finger holes (mouths of the bottles) to be arranged more closely together. This figure shows a top view where the player 600P stands near the center 600C of the radius of curvature of the finger holes (mouths 600U). The figure also shows a sideview of one of the bottles, the 5th bottle from the left (the 5th lowest note), which is typically note 1E using Natural Pitch Notation. Natural Pitch Notation uses the number for the more significant digit and the letter for the less significant digit, with the more significant digit leftmost and the less significant digit rightmost. The rightmost digit counts in base 8 from A to G. The first letter of the alphabet (“A”) is the lowest value for the rightmost digit, i.e. the counting begins with the first letter (not the third letter “C”).

Bulbs 660L could have air trapped in them, so bleeder valves 660B allow air to escape when they are filled with water. Valves 660B also serve to provide a continuous supply of water into the bottles, to keep the mouths brimming over. The mouths 600U face upward, or approximately upward, and thus runneth over with water, to form a meniscus that can be struck, tapped, or touched.

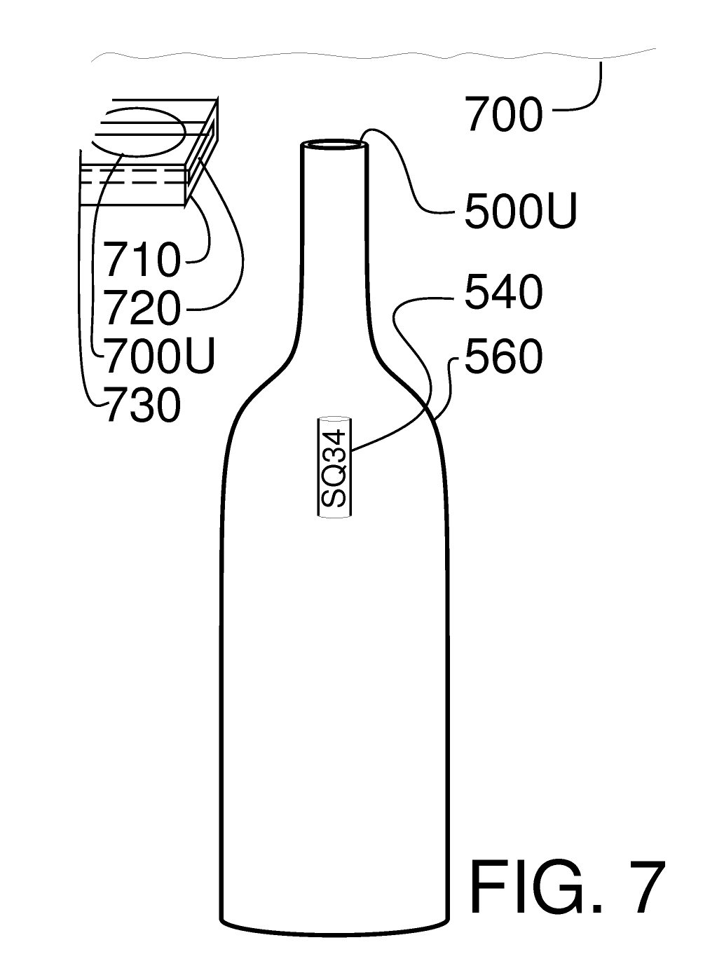

FIG. 7 illustrates an embodiment where the DC channel is implemented by a fipple or duct circuit that is completed by the touch of a finger onto Direct Current (DC) mouth 700U which is located beneath the surface of some water, e.g. in a basin or the like. The whole bottle is submerged under the water's surface 700.

I call the mouth 700U a Direct Current (DC) mouth because when pressed, it causes a steady continuous flow of water out of languid exit port 720 formed in duct 710. The duct 710 is supplied by a pump that pumps water into its input 730 that disappears out-of-frame in the drawing (i.e. not shown). So long as a finger is pressed against mouth 700U, Water flows from left to right from input 730 through duct 710 and out port 720 to spray across the mouth of bottle 560 to make a resonant tone picked up by hydrophone 540.

Letting the finger off mouth 700U introduces a big leak into the duct 710 allowing all or most of the pressure of the water from the pump to escape out the top of the hole in duct 710. The hole in the duct is mouth 700U.

Mouth 700U may extend right to the exit port 710 if desired, so that the finger can influence not just the amount of water flowing across the mouth 500U of bottle 560 but also, by way of “finger embouchure” the timbre of the sound can be changed depending on finger position and pressure profile and pressure distribution.

The player can block mouth 700U and also strike mouth 500U. Mouth 500U is an Alternating Current mouth because it does not sustain water flow, but merely introduces water flow in a transient (i.e. alternating pressure compressions and rarefactions) sense.

The player can interact with these two mouths in various combinations, to achieve an organlike sound with DC mouth 700U and a pianolike sound with AC mouth 500U.

In some embodiments mouth 700U may extend above the surface of the water, by way of a pipe leading from the leak or hole in duct 710 right up and out of the water. In this way, the player can play the bottle by blocking a water jet that appears above the water surface.

In another embodiment there is a keyboard where pressing keys completes the fipple circuit or duct circuit and also strikes the bottle, for the piano organ (“pianorgan”) or guitar violin (“guiolin”) effect, which I call the AC/DC effect. Thus a keyboard can be arranged so that hitting the keys “dings” the water in the bottles like a bell, and holding down the keys makes the water in the bottles sing.

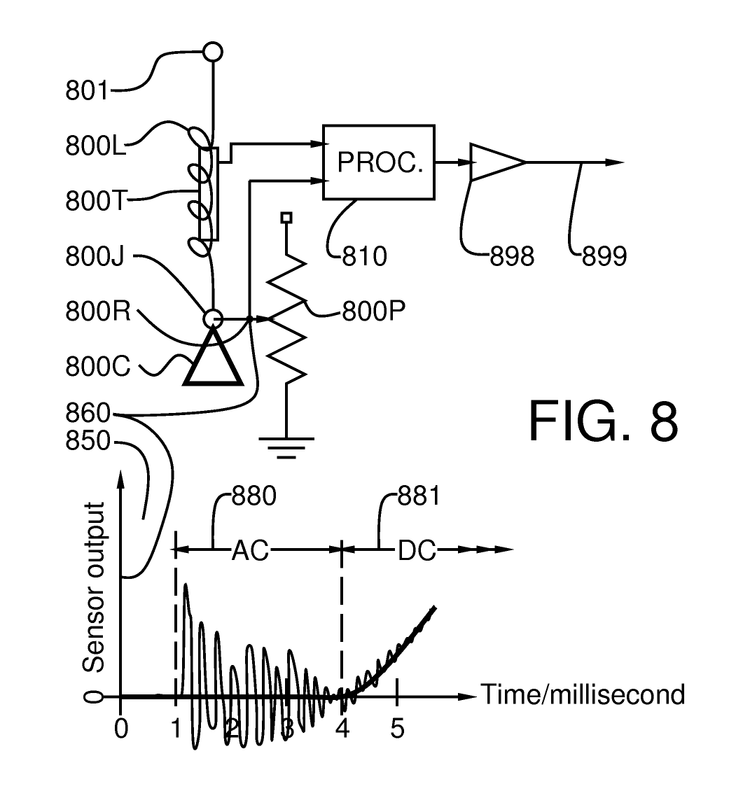

FIG. 8 illustrates the AC/DC arrangement by way of analogy to (or even an embodiment of the invention by) a mass, such as the mass of water in the neck of a bottle, or a hanging “weight”, as capacitor 800C, and spring, as inductor 800L.

Attached to the mass is shown a potentiometer which is, more typically of the invention, rather, a Wheatstone bridge, or similar sensor 800P. The output 860 of sensor 800P is supplied to a processor 810. A graph or plot 850 of the waveform of sensor output 860 as a function of time, will show an oscillatory behaviour when capacitor 800C is struck. If the capacitor is a mass (“weight”) suspended from a spring, then striking the weight will cause this behaviour. If the capacitor is the water in the neck of a bottle, then striking the water at the mouth of the bottle will exhibit this oscillation.

In playing the instrument of the invention, some embodiments allow for an ACDC type of interaction in which a player can strike something, to make it ding or ring like a bell or piano, and then the player can also grab and hold the something to make it sing or sustain like a violin or organ.

The situation in FIG. 8 depicts a situation in which a player strikes the mass with an impulse to cause it to vibrate, then waits a little while (approximately 3 milliseconds) and then grabs the mass and pulls it downwards and holds it down. Equivalently it depicts a situation when a player hits the mouth of a bottle with the index finger, then waits 3 milliseconds, and then slaps his or her palm down on the open mouth of the bottle, sealing the mouth, and applying a downward pressure on the water. This timescale is not so realistic, i.e. usually the time between striking and holding would be much more, but the plot timescale is simply chosen for illustrative processes.

On plot 850, the oscillations are depicted in two regimes, an AC regime 880 from when the player taps the mass, and a DC regime 881, depicting when the player presses and holds the mass.

It should also be noted that these two actions can happen together, i.e. the player can hit the mass and keep it displaced from its origin. For example, slapping the palm of the hand against an open bottle mouth will create a transient AC signal of alternating (oscillatory) pressure waves inside the bottle and also a steady-state DC signal resulting from an increase in the pressure inside the bottle.

The transient strike depicted in plot 850 occurs at approximately 1 millisecond and ends at a approximately 4 milliseconds, at which time the steady state strike begins to take effect from 4 milliseconds onwards. The transient oscillatory regime is what I call the DC regime. The regime where the mass is displaced away from its central resting position, 800R, is what I call the DC regime. This is where the user has grabbed and held it away from its central position.

To sense the DC regime, processor 810 computes an average voltage over a time interval, to sense a sustained trend of the signal being away from the central position, i.e. to sense sensor output 860 being nonzero for a sustained period of time beyond the mere oscillations of the AC regime. Although grabbing and holding capacitor 800C will often dampen its oscillations (i.e. introduce DC will often dampen AC), it is certainly possible for AC and DC to co-exist. For example, slapping the mouth of a bottle with the palm while simultaneously holding and pressing down tight, will cause oscillations with a DC offset, i.e. AC and DC together at the same time. In other situations, the player might tap the side of the mouth with the index finger to make the instrument ding, like a bell, and then slide the finger over to cover the whole mouth and make the note begin to sing like a violin after the ding, as depicted in plot 850.

Another means for determining DC content is to compute a Fourier Transform in processor 810. Typically in this embodiment, a sliding window Fourier Transform is computed, and subsonic components are considered DC. In this way, even if the sensor 800P can't sense all the way down to zero Hertz, a subsonic part of sensor 800P's output 860 signal can be used by processor 810 to make the AC signal sustain longer than it would ordinarily. If the sensor can't go all the way to zero Hertz, I still claim as an embodiment of my invention the use of subsonic frequency content to modify sonic frequency content. For example, processor 810 applies retroactive echo or reverberation to output 860 to a degree or extent controlled by a subsonic content in output 860. This retroactive echo or reverb uses a delay line or other soundstore, and reaches back into the past to loop back whenever the output 860 deviates from its central rest position 800R. The more deviance from rest position 800R, the more strongly processor 810 reaches into the past to reverberate output 860.

In other embodiments, the subsonic (i.e. DC) components of output 860 are frequency-shifted to the same or similar frequency as the AC components. I call this the shifterbank embodiment, because there is usually a bank of frequency shifters, one for each capacitor inductor pair (e.g. one for each bottle). For example, in the plot 850 we see that there are approximately ten cycles in the 3 millisecond AC regime. Let us suppose, therefore, that this sound comes from a 330 Hz “E” bottle.

In the shifterbank embodiment, processor 810 is programmed to take whatever subsonic content occurs, and shift this up to the pitch that the capacitor and inductor are supposed to normally resonate at. In this example, processor 810 takes any subsonic content and frequency-shifts this up to a 330 Hz note (i.e. an “E”). This can be performed by something as simple as a 330 Hz oscillator that has a voltage or strength controlled by the amount of subsonic content, to something more sophisticated such as a bank of 15 computer controlled oscillators that accept MIDI commands such as channel volume. In this case one oscillator on one channel can be controlled with channel volume change commands issued in proportion to how much subsonic (or DC) sound is present. I use sound in the broad sense, i.e. to denote pressure at any frequency.

In the shifterbank embodiment it is preferable to have a temperature sensor 800T that performs temperature compensation, so that the tuning of the oscillator matches the resonant frequency of whatever capacitor (e.g. bottle neck) and inductor (e.g. bottle bulb) is being used.

Voltage deviance from the average, thus outputs a frequency-shifted sound to match the resonance of the device (e.g. bottle).

The combined AC and DC signals are amplified by amplifier 898, and output by final instrument output 899.

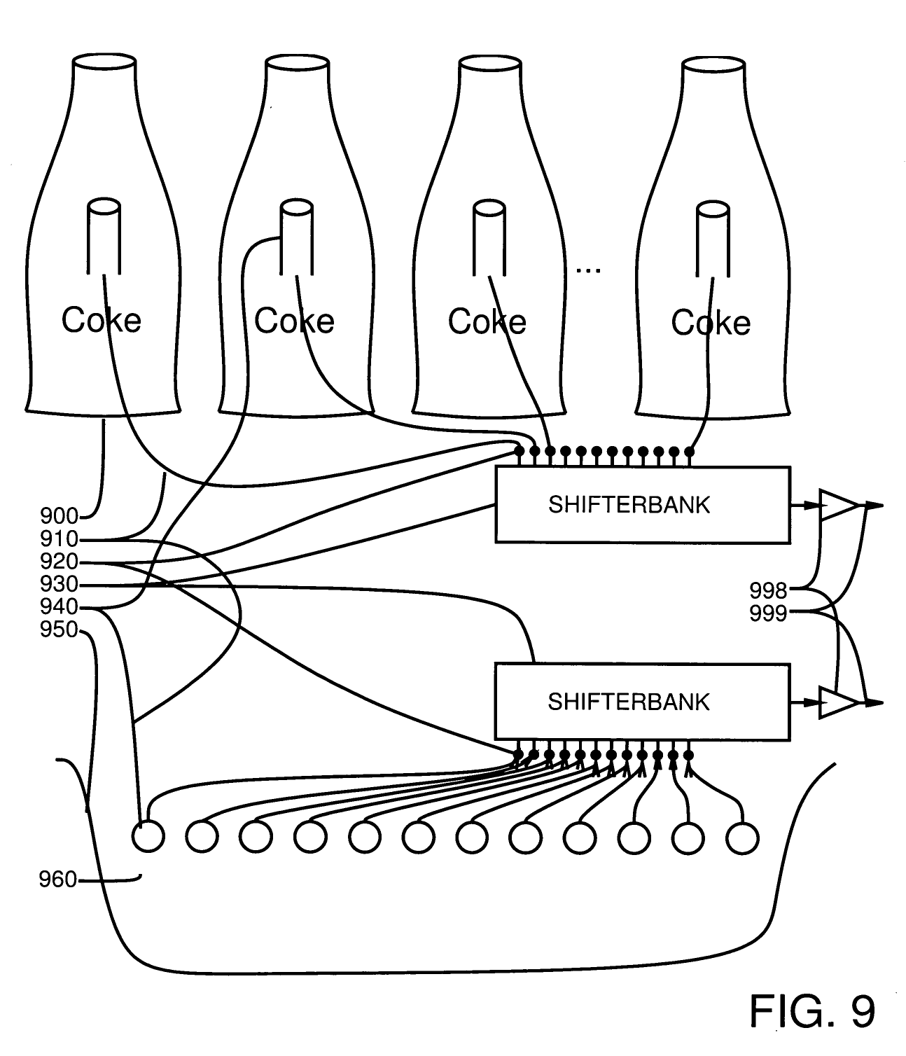

FIG. 9 illustrates a shifterbank embodiment of the invention that allows for the use of identical bottles for all of the different notes, or the use of open water regions not contained in bottles.

In the bottle embodiment 12 bottles 900 are used, whereas in the openwater embodiment 12 water regions 960 are used. A dozen hydrophones, Sensortech SQ34, denoted in the drawing as hydrophones 940, are used to pickup the sound or vibrations in water each bottle 900 or region 960. The hydrophones are each connected to a shifterbank 930 by wires 910. The shifterbank does a frequency-shift by convolution with an oscillatory wave packet recorded from a high quality Florence flask encased in concrete. In this way, ordinary Coke™ bottles, or even just slapping open water in a bathtub can be made to sound like a high quality hydraulophone.

Slapping the water at the mouths of bottles 900 or in tub 950 will produce frequency-shifted output amplified by amplifier 998 to output signal 999.

FIG. 10 illustrates a confluence instrument that makes sound from “soliq” (solid and liquid) by way of bulbs 1001L, 1002L, . . . 1008L which may be hydraulidiophonic (hydraulophonic and idiophonic), or otherwise elastic, in conjunction with necks 1001C, 1002C, . . . 1008C.

In this simple example, with 3 bottles shown, let us imagine there are 8 bottles with bulbs numbered 1001L, 1002L, . . . all the way up to the last bottle with bulb 1008L.

Satisfactory bulbs are “Coke spheres”, which are sold during the Christmas holiday season (the round Coke bottles are made to resemble Christmas tree decorations). Coke spheres have a neck that is approximately 26 mm long. In a prototype that I constructed, the leftmost bottle, corresponding to bulb 1001L, had a neck length of 305 mm, which I created by adding a 279 mm brass pipe neck extension to the 26 mm neck of the Coke sphere. The brass pipe is ⅞ inch tubing, i.e. tubing that has a ⅞ inch (approximately 22 mm) inside diameter.

The effective length is slightly longer than the actual length, due to end effects. In this case the effective length is approximately 314 mm.

The stated volume of a Coke sphere is 400 mL (0.4 liters), but the effective volume is approximately 93 liters, i.e. due to the elasticity and compliance of the bulb, it acts as a rigid 93 liter bulb would act.

Thus the effective volume of the bulb is approximately 222.5 times the actual volume.

The square root of that ratio is the change in frequency, i.e. when encapsulated in perfectly rigid concrete, the frequency goes up to about fifteen times (i.e. sqrt 222.5 times) the frequency when not encapsulated.

I use the tradename Nessonator™ to denote a hydraulic resonator in which vibrations in liquid occur. Typical Nessonators comprise a mass of water in a rigid pipe acting against a spring comprised of either a rigid bulb or an elastic bulb or another elastic member such as an elastic hose.

I use the term “Nessonance” to denote the tendency of a Nessonator to selectively enhance vibrations having certain specific frequencies.

This terminology is introduced in the literature in “User-Interfaces Based on the Water-Hammer Effect: Water-Hammer Piano as an Interactive Percussion Surface”, by Steve Mann et al., in Proceedings of the fifth international conference on Tangible, embedded, and embodied interaction (TEI), Funchal, Portugal, 23-26 Jan. 2011, pp. 1-8 (first paper in the proceedings), ACM (Association of Computing Machinery, ISBN: 978-1-4503-0478-8.

The prototype is for the notes corresponding to the lowest 12 white keys of the piano. The longest neck is 305 mm long, and its effective length is 314 mm long, and this is achieved by adding a 279 mm brass pipe (neck extension) to the original 26 mm Coke neck.

From the foregoing description, it will thus be evident that the present invention provides a design for a musical instrument or other highly expressive input device. As various changes can be made in the above embodiments and operating methods without departing from the spirit or scope of the invention, it is intended that all matter contained in the above description or shown in the accompanying drawings should be interpreted as illustrative and not in a limiting sense.

Variations or modifications to the design and construction of this invention, within is the scope of the invention, may occur to those skilled in the art upon reviewing the disclosure herein. Such variations or modifications, if within the spirit of this invention, are intended to be encompassed within the scope of any claims to patent protection issuing upon this invention.

What I claim is:

1. A liquid-based musical instrument, said instrument including one or more pipes each for being filled with liquid hydraulic fluid, each pipe having an end for being hydraulically open, and an end for connection to an hydraulic reservoir, said instrument also having one or more hydraulic reservoirs, each reservoir end of each pipe being connected to an hydraulic reservoir, said instrument also including a transformer for transforming vibrations in the hydraulic fluid to vibrations in air surrounding said instrument when the instrument is played.

2. The instrument of claim 1, where said one or more pipes are each a neck of a bottle, and said one or more reservoirs is a bulb of the bottle, and said transformer comprises an acoustic impedance matching device.

3. The instrument of claim 2, where said transformer includes an underwater electronic listening device for being inside of each of said bottles.

4. The instrument of claim 2, where said reservoirs are elastic elements formed from said bulbs of said bottles.

5. The instrument of claim 2, where said reservoirs comprise spherical plastic bottles.

6. The instrument of claim 2, where said reservoirs comprise spherical Coca Cola™ bottles commonly known as Coke Spheres.

7. The instrument of claim 1, where said pipes and reservoirs are rigid.

8. The instrument of claim 1, where said pipes are rigid and said reservoirs are elastic.

9. The instrument of claim 1, where said transformer includes an acoustic soundboard.

10. The instrument of claim 1, where said transformer includes an electronic listening device and electronic amplifier.

11. The instrument of claim 1, including at least one plastic bottle, said plastic bottle being said reservoir, where said bottle is completely filled with liquid, where a neck of said bottle is connected to said pipe, and said transformer includes at least one piezoelectric pickup arranged to sense mechanical vibrations in said plastic bottle.

12. The instrument of claim 1, said instrument including at least one pitch-bend pedal, said pedal raising or lowering a liquid level in at least one of said pipes.

13. The instrument of claim 1, including a number of bottles of varying size or shape, said size or shape selected such that each bottle forms a Helmholtz resonator having a frequency of a different note on a musical scale, when each bottle is filled with water, at least to a water level in a neck of said bottle, where each neck of each bottle is at least a part of said pipe, and each bulb of each bottle is said reservoir, and said transformer includes an hydrophone in each of said bottles, said hydrophones being connected to a mixer to combine electrical outputs of each of said hydrophones into a combined signal.

14. An instrument including the features of claim 1, where said instrument includes an alternating current (AC) sensor for sensing alternating vibrations in said instrument said instrument also including a direct current (DC) sensor for sensing direct changes in said instrument, said instrument further including a processor for combining an output of said AC sensor and DC sensor into an audible signal.

15. The instrument of claim 14, where said processor combines said AC and DC signals using a delay loop to reverberate echo said AC signal in proportion to said DC signal.

16. An infinite-sustain pipe piano organ including the features of claim 1, said infinite-sustain pipe piano organ including a sensor for sensing fluid properties in each of the bottles formed by said pipes and said reservoirs, said sensor for broadband sensing that includes direct-current and subsonic sensing, said sensor connected to a processor for reverberating an alternating current component of a signal from said sensor to a degree that is proportional to a subsonic component of said signal.

17. An instrument including the features of claim 1, said pipes being at least partially the necks of a plurality of Coke™ bottles, said transformers being electronic listening devices, said instrument further including a frequency shifter connected to each of said transformers.

18. A Coca-Cola bottle organ, including the features of claim 1, said pipes being the necks of a plurality of Coke™ bottles, said transformers being electronic listening devices, said instrument further including a shifterbank, an input of each shifterbank for each of a plurality of said listening devices, each arranged to listen to vibrations in liquid in each of said bottles.

19. A musical instrument for making music with liquids such as water, said musical instrument having one or more non-downward-facing mouths, each of said mouths being one end of a pipe, said instrument further including a space for elastically holding water to a second end of each of said pipes, said space comprised of a bulb for being filled with water, each of said pipes and spaces chosen to resonate together at one note of a musical scale, when said pipes and spaces are filled with liquid.

20. A method of playing music using Nessonators™, a Nessonator being defined as a hydraulic water resonator that has a mouth, a hydraulic capacitor in the form of a pipe, and an hydraulic inductor in the form of an elastic element, said method comprising the steps of:
arranging one or more Nessonators with their mouths facing upward, and filling each Nessonator at least partially with water;
fitting each Nessonator with an acoustic transformation device that converts vibrations in said water to vibrations in air;
striking the Nessonators to cause the water to vibrate.
